(19) United States
(12) Patent Application Publication
(10) Pub. No.: US 2026/0159774 A1
(43) Pub. Date: Jun. 11, 2026

(54) FLUORINE-CONTAINING ETHER COMPOUND, LUBRICANT FOR MAGNETIC RECORDING MEDIUM AND MAGNETIC RECORDING MEDIUM

(71) Applicant: RESONAC CORPORATION, Tokyo (JP)

(72) Inventor: Natsumi YOSHIMURA, Tokyo (JP)

(73) Assignee: RESONAC CORPORATION, Tokyo (JP)

(21) Appl. No.: 18/708,102

(22) PCT Filed: Nov. 8, 2022
(86) PCT No.: PCT/JP2022/041515

§ 371 Date: May 7, 2024

(30) Foreign Application Priority Data
Nov. 10, 2021 (JP) 2021-183678

(51) Int. Cl. C10M 107/42; C10N 40/18; G11B 5/72; G11B 5/725

(52) U.S. Cl. CPC C10M 107/42; G11B 5/7257; G11B 5/7266; C10M 2217/003; C10N 2040/18

(57) ABSTRACT

There is provided a fluorine-containing ether compound represented by the following formula:

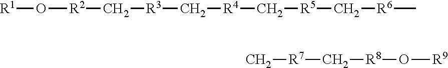

wherein R³, R⁵ and R⁷ are the same perfluoropolyether chains or at least one thereof is different; R², R⁴, R⁶ and R⁸ are each independently a divalent linking group having one or more polar groups; R¹ and R⁹ are each independently an end group containing a tertiary amine, and represented by —X—NR¹⁰R¹¹ (X is a divalent hydrocarbon group having 1 to 5 carbon atoms; R¹⁰ and R¹¹ are the same or different aliphatic groups; and R¹⁰ and R¹¹ may form a ring structure together with a nitrogen atom).

### TECHNICAL FIELD

The present invention relates to a fluorine-containing ether compound, a lubricant for a magnetic recording medium and a magnetic recording medium.

Priority is claimed on Japanese Patent Application No. 2021-183678, filed Nov. 10, 2021, the amount of which is incorporated herein by reference.

### BACKGROUND ART

The development of magnetic recording media suitable for high recording densities has progressed in order to improve the recording densities of magnetic recording and reproducing devices.

In the related art, there is a magnetic recording medium in which a recording layer is formed on a substrate and a protective layer made of carbon or the like is formed on the recording layer. The protective layer protects information recorded in the recording layer and enhances the slidability of a magnetic head. In addition, the protective layer covers the recording layer and prevents metals contained in the recording layer from being corroded by environmental substances.

However, sufficient durability of the magnetic recording medium cannot be obtained by simply providing the protective layer on the recording layer. Therefore, a lubricant is applied to the surface of the protective layer to form a lubricating layer having a thickness of about 0.5 to 3 nm. The lubricating layer improves the durability and protective power of the protective layer and prevents contamination substances from intruding into the magnetic recording medium.

In addition, after the lubricating layer is formed on the surface of the protective layer, a burnishing process may be performed to remove projections and particles present on the surface of the magnetic recording medium and improve the smoothness of the surface.

As a lubricant when the lubricating layer of the magnetic recording medium is formed, there is, for example, a lubricant containing a fluorine-based polymer having a repeating structure containing —CF₂— and having a polar group such as a hydroxyl group at an end.

For example, Patent Document 1 discloses a magnetic recording medium having a lubricating layer containing a fluorine-containing ether compound in which a group having a heterocycle is bonded at both ends of a perfluoropolyether chain.

Patent Document 2 discloses a polymer containing a group containing a heteroatom belonging to Group 15 in the periodic table and a perfluoropolyether chain.

Patent Document 3 discloses a compound in which the end of a perfluoropolyether chain is an amino group having a hydroxyl group.

Patent Document 4 discloses a fluorine-containing ether compound having perfluoropolyether chains on both sides of a glycerin structure and an end group containing an unsaturated bond.

Patent Document 5 discloses a magnetic disk having a lubricating layer containing a fluorine-containing ether compound having three perfluoropolyether chains in its molecule, end groups containing two or more polar groups disposed at both ends thereof, and having the same structure at the both ends.

Patent Document 6 discloses a magnetic disk having a lubricating layer containing a fluorine-containing ether compound having three perfluoropolyether chains in its molecule, different end groups disposed at both ends thereof, wherein one or both of the end groups contain two or more polar groups.

Patent Document 7 discloses a fluorine-containing ether compound having a perfluoropolyether chain, a group containing a tertiary amine bonded to a first end of the perfluoropolyether chain via a methylene group and a linking group, and an end group containing two or three polar groups bonded to a second end via a methylene group.

### CITATION LIST

### Patent Document

### Patent Document 1

PCT International Publication No. WO2018/139174

### Patent Document 2

Published Japanese Translation No. 2018-521183 of the PCT International Publication

### Patent Document 3

PCT International Publication No. WO2004/031261

### Patent Document 4

PCT International Publication No. WO2021/131993

### Patent Document 5

PCT International Publication No. WO2018/116742

### Patent Document 6

PCT International Publication No. WO2017/145995

### Patent Document 7

PCT International Publication No. WO2021/065382

### SUMMARY OF INVENTION

### Technical Problem

There is a demand for a further decrease in a floating height of a magnetic head in magnetic recording and reproducing devices. This requires a further decrease in the thickness of a lubricating layer in magnetic recording media.

However, if the thickness of the lubricating layer is reduced, the coatability of the lubricating layer decreases, which may reduce the wear resistance and corrosion resistance of the magnetic recording medium. Particularly, when tape burnishing is performed on the surface of the magnetic recording medium after the lubricating layer is formed, the corrosion resistance of the magnetic recording medium tends to be insufficient. For this reason, there is a demand for a lubricating layer that has a strong effect of inhibiting corrosion of the magnetic recording medium.

The present invention has been made in view of the above circumstances, and an object of the present invention is to provide a fluorine-containing ether compound that can be used as a material for a lubricant for a magnetic recording medium that can form a lubricating layer having excellent wear resistance and a strong effect of inhibiting corrosion of the magnetic recording medium.

In addition, an object of the present invention is to provide a lubricant for a magnetic recording medium which contains the fluorine-containing ether compound of the present invention, and can form a lubricating layer having excellent wear resistance and a strong effect of inhibiting corrosion of the magnetic recording medium.

In addition, an object of the present invention is to provide a magnetic recording medium having a lubricating layer containing the fluorine-containing ether compound of the present invention and having excellent wear resistance and corrosion resistance.

### Solution to Problem

The inventors conducted extensive studies in order to address the above problems. As a result, it was found that a fluorine-containing ether compound in which a perfluoropolyether chain is disposed in the center of a chain structure, a divalent linking group having one or more polar groups, a perfluoropolyether chain, and a divalent linking group having one or more polar groups are bonded to both ends thereof in that order via a methylene group (—CH₂—), and specific end groups containing a tertiary amine are ether-bonded (—O—) to both terminal ends could be used, and the present invention was completed.

Specifically, the present invention relates to the following aspects.

A first aspect of the present invention provides the following fluorine-containing ether compound.
[1]A fluorine-containing ether compound represented by the following Formula (1):

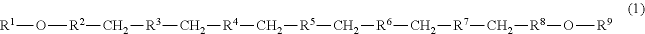

(in Formula (1), R³, R⁵ and R⁷ are the same perfluoropolyether chains or at least one thereof is different; R², R⁴, R⁶ and R⁸ are each independently a divalent linking group having one or more polar groups; and R¹ and R⁹ are each independently an end group containing a tertiary amine, and are represented by the following Formula (2))

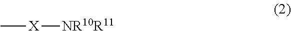

(in Formula (2), X is a divalent hydrocarbon group having 1 to 5 carbon atoms; R¹⁰ and R¹¹ are the same or different aliphatic groups; and R¹⁰ and R¹¹ may form a ring structure together with a nitrogen atom).

The fluorine-containing ether compound of the first aspect of the present invention preferably has characteristics described in [2] to [16] below. It is also preferable to arbitrarily combine two or more characteristics described in [2] to [16] below.
[2] The fluorine-containing ether compound according to [1],
   wherein, in Formula (2), —X— is represented by the following Formula (2-1):

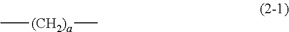

(in Formula (2-1), a is an integer of 2 or 3).
[3] The fluorine-containing ether compound according to [1] or [2],
   wherein, in Formula (2), R¹⁰ and R¹¹ are each independently a saturated aliphatic group having 1 to 4 carbon atoms, or R¹⁰ and R¹¹ form a 5- to 7-membered ring together with a nitrogen atom.
[4] The fluorine-containing ether compound according to any one of [1] to [3],
   wherein, in Formula (2), —NR¹⁰R¹¹ is a dimethylamino group or a diethylamino group.
[5] The fluorine-containing ether compound according to any one of [1] to [3],
   wherein, in Formula (2), —NR¹⁰R¹¹ is any one group selected from a pyrrolidine group, piperidine group, a morpholine group, and a hexamethyleneimine group.
[6] The fluorine-containing ether compound according to any one of [1] to [5],
   wherein, in Formula (1), all polar groups in R⁴ and R⁶ are hydroxyl groups.
[7] The fluorine-containing ether compound according to any one of [1] to [6],
   wherein, in Formula (1), R⁴ is represented by the following Formula (3), and R⁶ is represented by the following Formula (4):

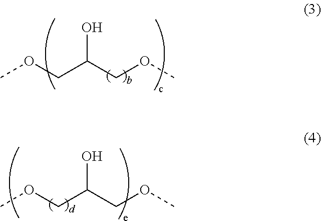

(in Formula (3), b is an integer of 1 to 3, c is an integer of 1 to 2; and an etheric oxygen atom on the left side in Formula (3) is bonded to R³—CH₂— in Formula (1))
(in Formula (4), d is an integer of 1 to 3, e is an integer of 1 to 2; and an etheric oxygen atom on the right side in Formula (4) is bonded to —CH₂—R⁷ in Formula (1)).
[8] The fluorine-containing ether compound according to any one of [1] to [7],
   wherein, in Formula (1), all polar groups in R² and R⁸ are hydroxyl groups.
[9] The fluorine-containing ether compound according to any one of [1] to [8],
   wherein, in Formula (1), R² and R⁸ are each independently represented by the following Formula (5):

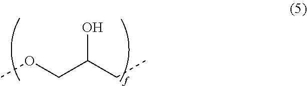

(in Formula (5), f is an integer of 1 to 2; and an etheric oxygen atom in Formula (5) is bonded to CH₂ adjacent to R², or CH₂ adjacent to R⁸ in Formula (1)).
[10] The fluorine-containing ether compound according to any one of [1] to [9],
   wherein, in Formula (1), R² and R⁸ each contain two polar groups.
[11] The fluorine-containing ether compound according to any one of [1] to [10],
   wherein, in Formula (1), R³, R⁵ and R⁷ are each independently represented by the following Formula (Rf):

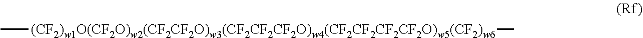

(in Formula (Rf), w2, w3, w4, and w5 indicate average degrees of polymerization, and are each independently 0 to 20; provided that all of w2, w3, w4, and w5 are not 0 at the same time; w1 and w6 are average values indicating the number of —CF₂-'s and are each independently 1 to 3; and the arrangement sequence of repeating units in Formula (Rf) is not particularly limited).
[12] The fluorine-containing ether compound according to any one of [1] to [11],
   wherein, in Formula (1), R³, R⁵ and R⁷ are each independently any of the following Formulae (6) to (10):

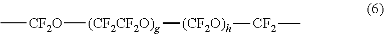

(in Formula (6), g and h indicate average degrees of polymerization, and are each 0.1 to 20)

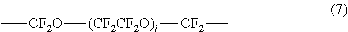

(in Formula (7), i indicates an average degree of polymerization, and is 0.1 to 20)

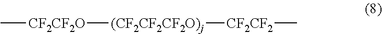

(in Formula (8), j indicates an average degree of polymerization, and is 0.1 to 20)

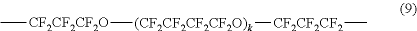

(in Formula (9), k indicates an average degree of polymerization, and is 0.1 to 10)

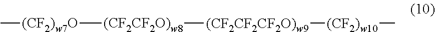

(in Formula (10), w8 and w9 indicate average degrees of polymerization, and are each independently 0.1 to 20; w7 and w10 are average values indicating the number of —CF₂-'s and are each independently 1 to 2).
[13] The fluorine-containing ether compound according to any one of [1] to [12],
   wherein, in Formula (1), R¹ and R⁹ are the same.
[14] The fluorine-containing ether compound according to any one of [1] to [13],
   wherein, in Formula (1), R² and R⁸ are the same.
[15] The fluorine-containing ether compound according to any one of [1] to [14],
   wherein, in Formula (1), R⁴ and R⁶ are the same.
[16] The fluorine-containing ether compound according to any one of [1] to [15], wherein the fluorine-containing ether compound has a number-average molecular weight in a range of 400 to 10,000.

A second aspect of the present invention provides the following lubricant for a magnetic recording medium.
[17]A lubricant for a magnetic recording medium including the fluorine-containing ether compound according to any one of [1] to [16].

A third aspect of the present invention provides the following magnetic recording medium.
[18]A magnetic recording medium in which at least a magnetic layer, a protective layer, and a lubricating layer are sequentially provided on a substrate,
   wherein the lubricating layer contains the fluorine-containing ether compound according to any one of [1] to [16].
[19] The magnetic recording medium according to [18],
   wherein the lubricating layer has an average film thickness of 0.5 nm to 2.0 nm.

### Advantageous Effects of Invention

The fluorine-containing ether compound of the present invention is the compound represented by Formula (1). Therefore, the fluorine-containing ether compound of the present invention can be used as a material for a lubricant for a magnetic recording medium that can form a lubricating layer having excellent wear resistance and a strong effect of inhibiting corrosion of the magnetic recording medium.

Since the lubricant for a magnetic recording medium of the present invention contains the fluorine-containing ether compound of the present invention, it is possible to form a lubricating layer having excellent wear resistance and a strong effect of inhibiting corrosion.

Since the magnetic recording medium of the present invention has a lubricating layer containing the fluorine-containing ether compound of the present invention, it has excellent wear resistance and corrosion resistance. Therefore, the magnetic recording medium of the present invention has excellent reliability and durability. In addition, since the magnetic recording medium of the present invention has a lubricating layer having excellent wear resistance and a strong effect of inhibiting corrosion, it is possible to reduce the thickness of the protective layer and/or the lubricating layer.

### BRIEF DESCRIPTION OF DRAWINGS

FIG. 1 is a schematic cross-sectional view showing an example of one embodiment of a magnetic recording medium of the present invention.

### DESCRIPTION OF EMBODIMENTS

Hereinafter, preferable examples of a fluorine-containing ether compound, a lubricant for a magnetic recording medium (hereinafter abbreviated as a “lubricant” in some cases) and a magnetic recording medium of the present invention will be described in detail. Here, the present invention is not limited only to the following embodiments. In the present invention, numbers, amounts, positions, ratios, materials, configurations and the like can be added, omitted, substituted, and changed without departing from the spirit and scope of the present invention.

### [Fluorine-Containing Ether Compound]

A fluorine-containing ether compound of the present embodiment is represented by the following Formula (1):

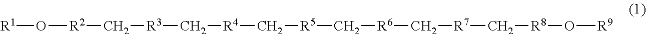

(in Formula (1), R³, R⁵ and R⁷ are the same perfluoropolyether chains or at least one thereof is different; R², R⁴, R⁶ and R⁸ are each independently a divalent linking group having one or more polar groups; and R¹ and R⁹ are each independently an end group containing a tertiary amine, and are represented by the following Formula (2))

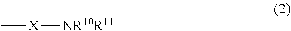

(in Formula (2), X is a divalent hydrocarbon group having 1 to 5 carbon atoms; R¹⁰ and R¹¹ are the same or different aliphatic groups; and R¹⁰ and R¹¹ may form a ring structure together with a nitrogen atom).
   (R¹ and R⁹)

In the fluorine-containing ether compound represented by Formula (1), R¹ and R⁹ are each independently an end group containing a tertiary amine, and are represented by Formula (2). In Formula (2), X is a divalent hydrocarbon group having 1 to 5 carbon atoms. R¹⁰ and R¹¹ are the same or different aliphatic groups. R¹⁰ and R¹¹ may form a ring structure together with a nitrogen atom

The fluorine-containing ether compound represented by Formula (1) has a molecular structure having excellent fluidity because R¹ and R⁹ are each independently an end group containing a tertiary amine represented by Formula (2). Therefore, in the lubricating layer containing the fluorine-containing ether compound of the present embodiment, a tertiary amine moiety (—NR¹⁰R¹¹ in Formula (2)) contained in R¹ and R⁹ in Formula (1) alleviates collision between the magnetic head and the protective layer and exhibits excellent wear resistance.

In the fluorine-containing ether compound represented by Formula (1), the structure of the tertiary amine contained in R¹ and R⁹ can be appropriately selected depending on the performance required for the lubricant containing the fluorine-containing ether compound.

In the fluorine-containing ether compound represented by Formula (1), X in Formula (2) is a divalent hydrocarbon group having 1 to 5 carbon atoms. Therefore, the distance between the polar groups in R² and R⁸ and the tertiary amine contained in R¹ and R⁹ is appropriate. The number of carbon atoms of X in Formula (2) is preferably 1 to 4 and more preferably 2 to 3.

The hydrocarbon group represented by X in Formula (2) may be a linear, branched, or cyclic group, and is preferably a linear group. In addition, the hydrocarbon group represented by X may be a saturated hydrocarbon group or an unsaturated hydrocarbon group. When the number of unsaturated bonds contained in the hydrocarbon group represented by X is 1 or less, this is preferable because it is difficult to fix the 3D structure of the fluorine-containing ether compound represented by Formula (1) and a lubricant that facilitates the interaction between the tertiary amine moiety contained in R¹ and R⁹ and the protective layer can be formed.

In Formula (2), —X— is preferably represented by the following Formula (2-1).

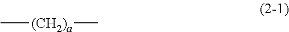

(in Formula (2-1), a is an integer of 2 or 3).

When —X— in Formula (2) is represented by Formula (2-1), the nitrogen atom in the end group containing a tertiary amine represented by Formula (2) is bonded to an alkylene group (—(CH₂)ₐ—) represented by Formula (2-1). —(CH₂)ₐ— represented by Formula (2-1) is a divalent linking group, and a in Formula (2-1) is an integer of 2 or 3. Therefore, the distance between the polar groups in R² and R⁸, and the nitrogen atom contained in the tertiary amine contained in R¹ and R⁹ is appropriate. As a result, the fluorine-containing ether compound in which —X— is represented by Formula (2-1) is less likely to cause intramolecular aggregation. Therefore, the lubricant containing this tends to be spread uniformly on the protective layer in the surface direction. Therefore, even if the thickness is thin, the lubricant containing the fluorine-containing ether compound in which —X— is represented by Formula (2-1) can cover the surface of the protective layer at a high coating rate, and can form a lubricating layer having better wear resistance and a strong effect of inhibiting corrosion.

a in Formula (2-1) is preferably 2 because the distance between the nitrogen atom in the tertiary amine and the polar groups in R² and R⁸ becomes more appropriate. In addition, when a in Formula (2-1) is 3 or less, because the alkylene group represented by Formula (2-1) is not too long, the mobility of the molecular end does not increase. Therefore, a fluorine-containing ether compound that can form a lubricant that facilitates the interaction between the tertiary amine moiety contained in R¹ and R⁹ and the protective layer is obtained.

In the end group containing a tertiary amine represented by Formula (2), R¹⁰ and R¹¹ are the same or different aliphatic groups. The aliphatic groups represented by R¹⁰ and R¹¹ in Formula (2) may be linear or branched, or may form a ring structure together with a nitrogen atom. The ring structure may be a ring structure containing one or more heteroatoms other than the nitrogen atom of the tertiary amine. In addition, R¹⁰ and R¹¹ may be a saturated aliphatic group or an unsaturated aliphatic group. R¹⁰ and R¹¹ are preferably saturated aliphatic groups in order to prevent the adhesion between the lubricating layer and the protective layer from becoming too high.

When the tertiary amine contained in the end group containing a tertiary amine represented by Formula (2) is an acyclic amine (R¹⁰ and R¹¹ in Formula (2) do not form a ring structure together with a nitrogen atom), it is preferable not to contain polar groups such as a hydroxyl group, an amino group, and a carboxy group. This is to prevent the adsorption force of the lubricant containing the fluorine-containing ether compound represented by Formula (1) with respect to the protective layer from becoming too strong.

When the tertiary amine contained in the end group containing a tertiary amine represented by Formula (2) is an acyclic amine (R¹⁰ and R¹¹ in Formula (2) do not form a ring structure together with a nitrogen atom), R¹⁰ and R¹¹ are each independently preferably a saturated aliphatic group having 1 to 4 carbon atoms. In this case, the tertiary amine (—NR¹⁰R¹¹) in Formula (2) does not cause excessive steric hindrance. Therefore, the tertiary amine contained in R¹ and R⁹ does not reduce the adsorption force of the lubricant containing the fluorine-containing ether compound represented by Formula (1) with respect to the protective layer, and a lubricating layer having a favorable coating rate is obtained. In addition, since the tertiary amine contained in R¹ and R⁹ does not cause excessive steric hindrance, collision between the magnetic head and the lubricant is less likely to occur, and floating of the magnetic head is less likely to become unstable. Moreover, since the tertiary amine contained in R¹ and R⁹ causes appropriate steric hindrance, the magnetic head does not get too close to the protective layer. As described above, it is possible to inhibit collision between the magnetic head and the protective layer, and an appropriate distance between the magnetic head and the protective layer is maintained. As a result, the lubricating layer containing such a fluorine-containing ether compound has excellent wear resistance.

Examples of saturated aliphatic groups having 1 to 4 carbon atoms include a methyl group, ethyl group, n-propyl group, isopropyl group, n-butyl group, isobutyl group, sec-butyl group, and tert-butyl group. Among these, a saturated aliphatic group having 1 to 2 carbon atoms is preferable. Specifically, R¹⁰ and R¹¹ are each independently preferably a methyl group or ethyl group, and R¹⁰ and R¹¹ are more preferably the same. That is, when the tertiary amine contained in the end group containing a tertiary amine represented by Formula (2) is an acyclic amine, the tertiary amine (—NR¹⁰R¹¹) is preferably any one selected from among a dimethylamino group, a methylethylamino group, and a diethylamino group, and more preferably a dimethylamino group or a diethylamino group because it is easy to synthesize.

Specific examples of acyclic amines include a dimethylamino group, diethylamino group, dipropyl amino group, diisopropyl amino group, di-n-butyl amino group, diisobutyl amino group, di-sec-butyl amino group, di-tert-butyl amino group, ethylmethyl amino group, n-propylmethyl amino group, isopropylmethyl amino group, n-butylmethyl amino group, isobutylmethyl amino group, sec-butyl methyl amino group, tert-butyl methyl amino group, ethyl n-propyl amino group, ethyl isopropyl amino group, ethyl n-butyl amino group, ethyl isobutyl amino group, sec-butylethyl amino group, tert-butylethyl amino group, isopropylpropyl amino group, n-butylpropyl amino group, (2-methylpropyl) (propyl)amino group, N-sec-butylpropyl amino group, N-tert-butylpropyl amino group, N-(1-methylethyl)-1-butyl amino group, N-isopropyl-2-methyl-1-propyl amino group, N-(1-methylethyl)-2-butyl amino group, N-isopropyl-2-methyl-2-propyl amino group, butyl isobutyl amino group, butyl-sec-butyl amino group, butyl-tert-butyl amino group, N-(2-methylpropyl)-2-butyl amino group, N-(1,1-dimethylethyl)-2-methylpropyl amino group, and N-(1,1-dimethylethyl)-2-butyl amino group.

When the tertiary amine contained in the end group containing a tertiary amine represented by Formula (2) is a cyclic amine (R¹⁰ and R¹¹ in Formula (2) form a ring structure together with a nitrogen atom), it is preferable that R¹⁰ and R¹¹ form a 5- to 7-membered ring together with a nitrogen atom. In this case, since the tertiary amine (—NR¹⁰R¹¹) in Formula (2) has appropriate fluidity, excessive steric hindrance does not occur. Therefore, the tertiary amine contained in R¹ and R⁹ does not reduce the adsorption force of the lubricant containing the fluorine-containing ether compound represented by Formula (1) with respect to the protective layer, and a lubricating layer having a favorable coating rate is obtained. In addition, the lubricating layer containing the fluorine-containing ether compound alleviates collision between the magnetic head and the protective layer and exhibits excellent wear resistance because the tertiary amine contained in R¹ and R⁹ has appropriate fluidity.

The ring structure of the cyclic amine may contain one or more heteroatoms other than the nitrogen atom of the tertiary amine. Examples of heteroatoms other than the nitrogen atom of the tertiary amine include an oxygen atom and/or a nitrogen atom.

When the tertiary amine contained in the end group containing a tertiary amine represented by Formula (2) is a cyclic amine (R¹⁰ and R¹¹ in Formula (2) form a ring structure together with a nitrogen atom), the cyclic amine may have a substituent. When the cyclic amine has a substituent, in order to prevent the adsorption force of the lubricant containing the fluorine-containing ether compound represented by Formula (1) with respect to the protective layer from becoming too strong, it is preferable not to contain polar groups such as a hydroxyl group, an amino group, and a carboxy group. Specific examples of substituents that the cyclic amine may have include, for example, an alkyl group having 1 to 3 carbon atoms. The bonding position of the substituent in the cyclic amine having a substituent is not particularly limited, and the substituent may be bonded to any carbon atom constituting the cyclic amine.

When the tertiary amine contained in the end group containing a tertiary amine represented by Formula (2) is a cyclic amine (R¹⁰ and R¹¹ in Formula (2) form a ring structure together with a nitrogen atom), specific examples of cyclic amines include an ethyleneimine group, azacyclobutane group, pyrrolidine group, piperidine group, morpholine group, hexamethyleneimine group, heptamethyleneimine group, and octamethyleneimine group. Here, the nitrogen atom in these groups is bonded to —X—. The tertiary amine (—NR¹⁰R¹¹) in Formula (2) is preferably any one group selected from a pyrrolidine group, piperidine group, a morpholine group, and a hexamethyleneimine group, and particularly, a pyrrolidine group or a morpholine group is preferable because the lubricant containing the fluorine-containing ether compound represented by Formula (1) can form a lubricating layer having excellent wear resistance.

In addition, in the fluorine-containing ether compound represented by Formula (1), R¹ and R², and R⁸ and R⁹ are bonded by an ether bond (—O—). Therefore, the fluorine-containing ether compound represented by Formula (1) has an appropriately flexible molecular structure. As a result, the lubricating layer containing this has favorable interaction between R¹ and R², and R⁸ and R⁹ in the fluorine-containing ether compound and the protective layer disposed in contact with the lubricating layer. Therefore, the lubricating layer containing the fluorine-containing ether compound of the present embodiment is easily adsorbed to the protective layer, has excellent adhesion to the protective layer, and has excellent corrosion resistance and wear resistance.

(R² and R⁸)

In the fluorine-containing ether compound represented by Formula (1), a divalent linking group having one or more polar groups (R² and R⁸) is disposed between the end group containing a tertiary amine represented by Formula (2) (R¹ and R⁹) and the perfluoropolyether chain (R³ and R⁷). R² and R⁸ contain one or more polar groups. Therefore, when a lubricating layer is formed on a protective layer using the lubricant containing the fluorine-containing ether compound represented by Formula (1), interaction between the polar groups in R² and R⁸ in the lubricating layer and the protective layer occurs. Therefore, the lubricating layer containing the fluorine-containing ether compound represented by Formula (1) is easily adsorbed to the protective layer, has excellent adhesion to the protective layer, and has excellent wear resistance.

Examples of polar groups of linking groups represented by R² and R⁸ include a hydroxyl group, an amino group, and a carboxy group. Among these polar groups, it is preferable to include a hydroxyl group as a polar group, and it is more preferable that all polar groups in R² and R⁸ be hydroxyl groups because a fluorine-containing ether compound that can form a lubricating layer having an appropriate affinity for the protective layer is obtained.

The numbers of polar groups contained in R² and R⁸ are each 1 or more, preferably each 1 to 3, more preferably each 1 or 2, and it is most preferable to each include two polar groups. When the numbers of polar groups contained in R² and R⁸ are each 2, in the lubricating layer containing the fluorine-containing ether compound of the present embodiment, the interaction between the hydroxyl groups in R² and R⁸ and the protective layer becomes even better, and the adhesion to the protective layer becomes more excellent.

The linking groups represented by R² and R⁸ are preferably a linking group having 1 to 10 carbon atoms and more preferably a linking group having 3 to 6 carbon atoms.

The linking groups represented by R² and R⁸ are preferably a linking group containing a methylene group (—CH(OH)—) substituted with a hydroxyl group, a methylene group (—CH₂—) and/or an ether bond (—O—), and more preferably a linking group containing one or more of each of a methylene group (—CH(OH)—) substituted with a hydroxyl group, a methylene group (—CH₂—) and an ether bond (—O—).

Specifically, more preferably, the linking group represented by R² and/or R⁸ is represented by the following Formula (5), and still more preferably, the linking groups represented by R² and R⁸ are each independently represented by the following Formula (5).

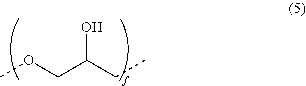

(in Formula (5), f is an integer of 1 to 2; and the etheric oxygen atom in Formula (5) is bonded to CH₂ adjacent to R², or CH₂ adjacent to R⁸ in Formula (1)).

f in Formula (5) is an integer of 1 to 2. Therefore, when R² and R⁸ are represented by Formula (5), R² and R⁸ each contain one or two hydroxyl groups (—OH), which are polar groups. Therefore, in the lubricating layer containing the fluorine-containing ether compound of the present embodiment, favorable interaction occurs between the lubricating layer and the protective layer, and excellent adhesiveness (adhesion) to the protective layer is obtained. In addition, since the linking group represented by Formula (5) contains an ether bond (—O—), it imparts appropriate flexibility to the molecular structure of the fluorine-containing ether compound represented by Formula (1). As a result, when R² and R⁸ are represented by Formula (5), in the fluorine-containing ether compound of the present embodiment, the lubricating layer containing this is easily adsorbed to the protective layer, and the adhesion between the lubricating layer and the protective layer is excellent compared to, for example, a fluorine-containing ether compound in which R¹ and R³ (and/or R⁷ and R⁹) are directly bonded.

Since f in Formula (5) is 1 or more, when a lubricating layer is formed on a protective layer using the lubricant containing the fluorine-containing ether compound of the present embodiment, the interaction between the hydroxyl groups in R² and R⁸ in the lubricating layer and the protective layer occurs. When f in Formula (5) is 2, the interaction between the hydroxyl groups in R² and R⁸ and the protective layer becomes even better, and a fluorine-containing ether compound that allows a lubricating layer with better adhesion to the protective layer to be obtained is obtained. In addition, since f in Formula (5) is 2 or less, the polarity of the fluorine-containing ether compound does not become too high due to too many hydroxyl groups in R² and R⁸. Therefore, it is possible to prevent the lubricating layer containing the fluorine-containing ether compound from adhering to a magnetic head as a foreign matter (smear), wherein such an adhesion tends to occur when the polarity of the fluorine-containing ether compound is too high, and it is possible to prevent the occurrence of pickup. In addition, in Formula (5), when f is 2, the hydroxyl groups contained in R² and R⁸ are disposed at an appropriate distance.

(R⁴ and R⁶)

In the fluorine-containing ether compound represented by Formula (1), R⁴ and R⁶ are each independently a divalent linking group having one or more polar groups. Since the linking groups represented by R⁴ and R⁶ contain one or more polar groups, when a lubricating layer is formed on a protective layer using the lubricant containing the fluorine-containing ether compound represented by Formula (1), interaction between the polar groups in R⁴ and R⁶ in the lubricating layer and the protective layer occurs, and favorable adhesion to the protective layer is obtained.

Examples of polar groups of linking groups represented by R⁴ and R⁶ include a hydroxyl group, an amino group, and a carboxy group. Among these polar groups, it is preferable to include a hydroxyl group as a polar group and it is more preferable that all polar groups in R⁴ and R⁶ be hydroxyl groups because a fluorine-containing ether compound that can form a lubricating layer having an appropriate affinity for the protective layer is obtained.

The numbers of polar groups contained in R⁴ and R⁶ are each 1 or more, preferably 1 to 3, and more preferably 1 or 2, and it is most preferable to include one polar group. When the numbers of polar groups contained in R⁴ and R⁶ are each 1, the lubricating layer containing the fluorine-containing ether compound of the present embodiment has appropriate hydrophobicity, and a better effect of inhibiting corrosion of the magnetic recording medium is exhibited.

The linking groups represented by R⁴ and R⁶ are preferably a linking group having 1 to 10 carbon atoms and more preferably a linking group having 3 to 6 carbon atoms.

The linking groups represented by R⁴ and R⁶ are preferably a linking group containing a methylene group (—CH(OH)—) substituted with a hydroxyl group, a methylene group (—CH₂—) and/or an ether bond (—O—), and more preferably a linking group containing one or more of each of a methylene group (—CH(OH)—) substituted with a hydroxyl group, a methylene group (—CH₂—) and an ether bond (—O—).

Specifically, the linking group represented by R⁴ is more preferably represented by the following Formula (3). In addition, the linking group represented by R⁶ is more preferably represented by the following Formula (4). In the fluorine-containing ether compound represented by Formula (1), more preferably, the linking group represented by R⁴ is represented by Formula (3) and the linking group represented by R⁶ is represented by Formula (4).

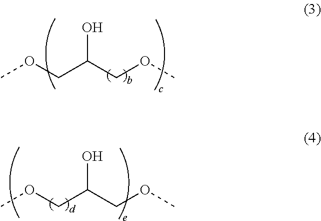

(in Formula (3), b is an integer of 1 to 3, c is an integer of 1 to 2; and an etheric oxygen atom on the left side in Formula (3) is bonded to R³—CH₂— in Formula (1))
(in Formula (4), d is an integer of 1 to 3, e is an integer of 1 to 2; and an etheric oxygen atom on the right side in Formula (4) is bonded to —CH₂—R⁷ in Formula (1)).

When the linking group represented by R⁴ is represented by Formula (3) and the linking group represented by R⁶ is represented by Formula (4), the oxygen atoms disposed at both ends of R⁴ and both ends of R⁶ are bonded to methylene groups (—CH₂—) disposed on both sides of R⁴ and R⁶ to form an ether bond (—O—). The four ether bonds formed in this manner impart appropriate flexibility to the fluorine-containing ether compound represented by Formula (1), increase the affinity between the hydroxyl groups of R⁴ and R⁶ and the protective layer, and improve the adhesion to the protective layer.

b in Formula (3) is an integer of 1 to 3, and d in Formula (4) is an integer of 1 to 3. Therefore, when R⁴ is represented by Formula (3) and R⁶ is represented by Formula (4), in the fluorine-containing ether compound represented by Formula (1), the number of carbon atoms contained in each of R⁴ and R⁶ is appropriate, and favorable hydrophobicity is obtained. Therefore, the lubricating layer containing this exhibits a better effect of inhibiting corrosion of the magnetic recording medium. It is most preferable that both b in Formula (3) and d in Formula (4) be 1 because a fluorine-containing ether compound is easily synthesized.

c in Formula (3) is an integer of 1 to 2, and e in Formula (4) is an integer of 1 to 2. Therefore, when R⁴ is represented by Formula (3) and R⁶ is represented by Formula (4), R⁴ and R⁶ each contain one or more hydroxyl groups. As a result, in the lubricating layer containing the fluorine-containing ether compound represented by Formula (1), favorable adhesion to the protective layer is obtained due to the interaction between the hydroxyl groups contained in R⁴ and R⁶ and the protective layer. Moreover, since the number of hydroxyl groups contained in R⁴ and R⁶ is 1 or 2, the number of hydroxyl groups in the molecule does not become too large, and appropriate hydrophobicity is maintained.

(R³, R⁵ and R⁷)

In the fluorine-containing ether compound represented by Formula (1), R³, R⁵ and R⁷ are the same perfluoropolyether chains or at least one thereof is different (hereinafter referred to as a “PFPE chain” in some cases). When a lubricant containing the fluorine-containing ether compound of the present embodiment is applied to a protective layer to form a lubricating layer, the PFPE chains represented by R³, R⁵ and R⁷ cover the surface of the protective layer, impart lubricity to the lubricating layer, and reduce a frictional force between the magnetic head and the protective layer. In addition, due to their low surface energy, the PFPE chains impart water resistance to the lubricating layer containing the fluorine-containing ether compound of the present embodiment, and improve corrosion resistance of the magnetic recording medium on which the lubricating layer is provided. Since the fluorine-containing ether compound represented by Formula (1) contains three PFPE chains represented by R³, R⁵ and R⁷ in the molecule, it can form a lubricating layer having a strong effect of inhibiting corrosion.

R³, R⁵ and R⁷ may be PFPE chains, and can be appropriately selected depending on the performance required for the lubricant containing the fluorine-containing ether compound. Examples of PFPE chains include those composed of perfluoromethylene oxide polymers, perfluoroethylene oxide polymers, perfluoro-n-propylene oxide polymers, perfluoroisopropylene oxide polymers, and copolymers thereof.

R³, R⁵ and R⁷ may each independently have, for example, a structure represented by the following Formula (Rf) derived from a perfluoroalkylene oxide polymer or copolymer.

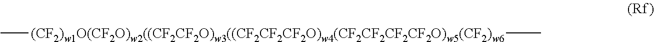

(in Formula (Rf), w2, w3, w4, and w5 indicate average degrees of polymerization, and are each independently 0 to 20; provided that all of w2, w3, w4, and w5 are not 0 at the same time; w1 and w6 are average values indicating the number of —CF₂-'s and are each independently 1 to 3; and the arrangement sequence of repeating units in Formula (Rf) is not particularly limited).

In Formula (Rf), w2, w3, w4, and w5 indicate average degrees of polymerization, and are each independently 0 to 20, and are preferably 0 to 15 and more preferably 0 to 10.

In Formula (Rf), w1 and w6 are average values indicating the number of —CF₂-'s and are each independently 1 to 3. w1 and w6 are determined according to the structure of repeating units disposed at the ends of the chain structure in the polymer represented by Formula (Rf).

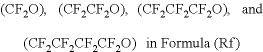

are repeating units. The arrangement sequence of repeating units in Formula (Rf) is not particularly limited. In addition, the number of types of repeating units in Formula (Rf) is not particularly limited.

Specifically, R³, R⁵ and R⁷ in Formula (1) are each independently preferably any of the following Formulae (6) to (10):

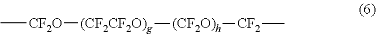

(in Formula (6), g and h indicate average degrees of polymerization, and are each 0.1 to 20)

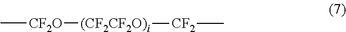

(in Formula (7), i indicates an average degree of polymerization, and represents 0.1 to 20)

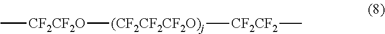

(in Formula (8), j indicates an average degree of polymerization, and represents 0.1 to 20)

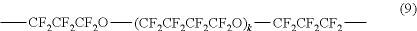

(in Formula (9), k indicates an average degree of polymerization, and represents 0.1 to 10)

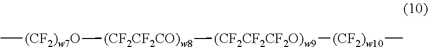

(in Formula (10), w8 and w9 indicate average degrees of polymerization, and are each independently 0.1 to 20; w7 and w10 are average values indicating the number of —CF₂-'s and are each independently 1 to 2).

g and h indicating average degrees of polymerization in Formula (6) are each 0.1 to 20, i indicating an average degree of polymerization in Formula (7) is 0.1 to 20, j indicating an average degree of polymerization in Formula (8) is 0.1 to 20, and k indicating an average degree of polymerization in Formula (9) is 0.1 to 10. When g, h, i, j, and k are 0.1 or more, a fluorine-containing ether compound that allows a lubricating layer that has favorable wear resistance and can further inhibit corrosion of the magnetic recording medium to be obtained is obtained. In addition, when g, h, i, and j are each 20 or less, and k is 10 or less, this is preferable because the viscosity of the fluorine-containing ether compound does not become too high, and a lubricant containing this is easily applied. g, h, i, j, and k indicating average degrees of polymerization are all preferably 2 to 10 and more preferably 2 to 8 because a fluorine-containing ether compound which easily wets and spreads on the protective layer and allows a lubricating layer having a uniform film thickness to be easily obtained is obtained. As necessary, for example, 2 to 4, or 3 to 6 may be used.

The arrangement sequence of repeating units (CF₂CF₂O) and (CF₂O) in Formula (6) is not particularly limited. Formula (6) may include any of a random copolymer, a block copolymer, and an alternating copolymer composed of monomer units (CF₂CF₂O) and (CF₂O).

In Formula (10), w8 and w9 indicating average degrees of polymerization are each independently 0.1 to 20, are preferably 0.1 to 15, and more preferably 1 to 10. In Formula (10), w7 and w10 are average values indicating the number of —CF₂-′ and are each independently 1 to 2. w7 and w10 are determined according to the structure of repeating units disposed at the ends of the chain structure in the polymer represented by Formula (10).

The arrangement sequence of repeating units (CF₂CF₂O) and (CF₂CF₂CF₂O) in Formula (10) is not particularly limited. Formula (10) may include any of a random copolymer, a block copolymer, and an alternating copolymer composed of monomer units (CF₂CF₂O) and (CF₂CF₂CF₂O).

When R³, R⁵ and R⁷ in Formula (1) are each independently any of Formula (6) to Formula (10), this is preferable because it is easy to synthesize the fluorine-containing ether compound. In addition, when R³, R⁵ and R⁷ are each independently any of Formula (6) to Formula (10), the ratio of the number of oxygen atoms (the number of ether bonds (—O—)) to the number of carbon atoms in the PFPE chain becomes appropriate. Therefore, a fluorine-containing ether compound having an appropriate hardness is obtained. Therefore, the fluorine-containing ether compound applied onto the protective layer is less likely to aggregate on the protective layer, and a thinner lubricating layer can be formed with a sufficient coating rate.

In the fluorine-containing ether compound represented by Formula (1), when R³, R⁵ and R⁷ are each independently Formula (6), Formula (7) or Formula (8), this is more preferable because the raw material is easily obtained.

In the fluorine-containing ether compound represented by Formula (1), the PFPE chains represented by R³, R⁵ and R⁷ are the same or at least one thereof is different. That is, some or all of R³, R⁵ and R⁷ may be the same or all of them may be different from each other.

In the present embodiment, a case in which the PFPE chains are the same also includes a case in which the repeating units of the PFPE chains are the same and the average degrees of polymerization are different.

In the fluorine-containing ether compound represented by Formula (1), R¹ and R⁹ may be the same as or different from each other. When R¹ and R⁹ are the same, the adsorption forces of R¹ and R⁹ with respect to the protective layer are the same. Therefore, this is preferable because a fluorine-containing ether compound which uniformly easily wets and spreads on the protective layer and allows a lubricating layer having a uniform film thickness to be easily obtained is obtained.

In addition, R² and R⁸ may be the same as or different from each other. “R² and R⁸ are the same” means that atoms contained in R² and atoms contained in R⁸ are disposed symmetrically with respect to R⁵ in Formula (1). When R² and R⁸ are the same, the adsorption forces of R² and R⁸ with respect to the protective layer are the same. Therefore, this is preferable because a fluorine-containing ether compound which uniformly easily wets and spreads on the protective layer and allows a lubricating layer having a uniform film thickness to be easily obtained is obtained.

In addition, when R¹ and R⁹ are the same, and R² and R⁸ are the same, the adsorption forces of R¹—O—R² and R⁸—O—R⁹ with respect to the protective layer are the same. Therefore, a fluorine-containing ether compound that more uniformly easily wets and spreads on the protective layer is obtained. In addition, when R¹—O—R² and R⁸—O—R⁹ are the same, the fluorine-containing ether compound may be easily synthesized with fewer production processes.

In addition, in the fluorine-containing ether compound represented by Formula (1), when R³ and R⁷ are the same, if R¹ and R⁹ are the same, and R² and R⁸ are the same, the fluorine-containing ether compound is synthesized more easily.

In the fluorine-containing ether compound represented by Formula (1), R⁴ and R⁶ may be the same as or different from each other. “R⁴ and R⁶ are the same” means that atoms contained in R⁴ and atoms contained in R⁶ are disposed symmetrically with respect to R⁵ in Formula (1). When R⁴ and R⁶ are the same, this is preferable because the fluorine-containing ether compound may be easily synthesized with fewer production processes. When R⁴ is represented by Formula (3) and R⁶ is represented by Formula (4), “R⁴ and R⁶ are the same” means that b in Formula (3) and d in Formula (4) are the same and c in Formula (3) and e in Formula (4) are the same.

In addition, in the fluorine-containing ether compound represented by Formula (1), when R⁴ and R⁶ are the same, and R³ and R⁷, R² and R⁸, R¹ and R⁹ are the same, a compound having a symmetrical structure centered on R⁵ is obtained. Such a compound is preferable because it can be synthesized more efficiently and easily with fewer production processes. In addition, when the fluorine-containing ether compound represented by Formula (1) has a symmetrical structure centered on R⁵, it uniformly easily wets and spreads on the protective layer and allows a lubricating layer having a uniform film thickness to be easily obtained. In addition, when the fluorine-containing ether compound represented by Formula (1) has a symmetrical structure centered on R⁵ and R⁵ is the same as R³ and R⁷, it more uniformly easily wets and spreads on the protective layer and allows a lubricating layer having a more uniform film thickness to be easily obtained.

Specifically, the fluorine-containing ether compound represented by Formula (1) is preferably any of compounds represented by the following Formulae (A) to (I). Here, in Formulae (A) to (I), since qa, pb, mc, nc, pd, qd, pe, qe, mf, nf, pf, pg, qh, and qi are values indicating average degrees of polymerization, they are not necessarily integers.

In all compounds represented by the following Formulae (A) to (I), R¹ and R⁹ are represented by Formula (2), —X— in Formula (2) is represented by Formula (2-1), R² and R⁸ are the same and represented by Formula (5), R⁴ and R⁶ are the same, R⁴ is represented by Formula (3), R⁶ is represented by Formula (4), and R³ and R⁷ are the same. In all compounds represented by the following Formulae (A) to (G), and (I), R¹ and R⁹ are the same. In all compounds represented by the following Formulae (A) to (C), and (G) to (I), R³, R⁵, R⁷ are the same.

In all compounds represented by the following Formulae (A) to (G), in R² and R⁸, f in Formula (5) is 2, in R⁴, b in Formula (3) is 1 and c is 1, and in R⁶, d in Formula (4) is 1 and e is 1.

In the compound represented by the following Formula (A), R¹ and R⁹ are represented by Formula (2), the tertiary amine is a morpholine group, and a in Formula (2-1) is 2. All of R³, R⁵, and R⁷ are PFPE chains represented by Formula (8).

In the compound represented by the following Formula (B), R¹ and R⁹ are represented by Formula (2), the tertiary amine is a morpholine group, and a in Formula (2-1) is 3. All of R³, R⁵, and R⁷ are PFPE chains represented by Formula (7).

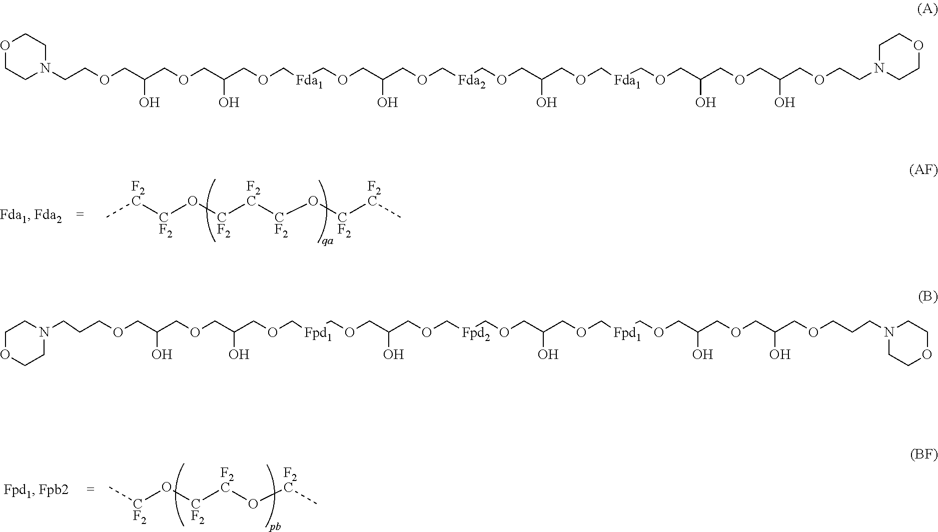

(in Formula (A), Fda₁ and Fda₂ are represented by Formula (AF); in Fda₁ and Fda₂, qa indicating an average degree of polymerization represents 0.1 to 20; and qa in Fda₁ and qa in Fda₂ may be the same as or different from each other)
(in Formula (B), Fpb₁ and Fpb₂ are represented by Formula (BF); in Fpb₁ and Fpb₂, pb indicating an average degree of polymerization represents 0.1 to 20; and pb in Fpb₁ and pb in Fpb₂ may be the same as or different from each other).

In the compound represented by the following Formula (C), R¹ and R⁹ are represented by Formula (2), the tertiary amine is a pyrrolidine group, and a in Formula (2-1) is 2. All of R³, R⁵, and R⁷ are PFPE chains represented by Formula (6).

In the compound represented by the following Formula (D), R¹ and R⁹ are represented by Formula (2), the tertiary amine is a pyrrolidine group, and a in Formula (2-1) is 3. R³ and R⁷ are PFPE chains represented by Formula (7), and R⁵ is a PFPE chain represented by Formula (8).

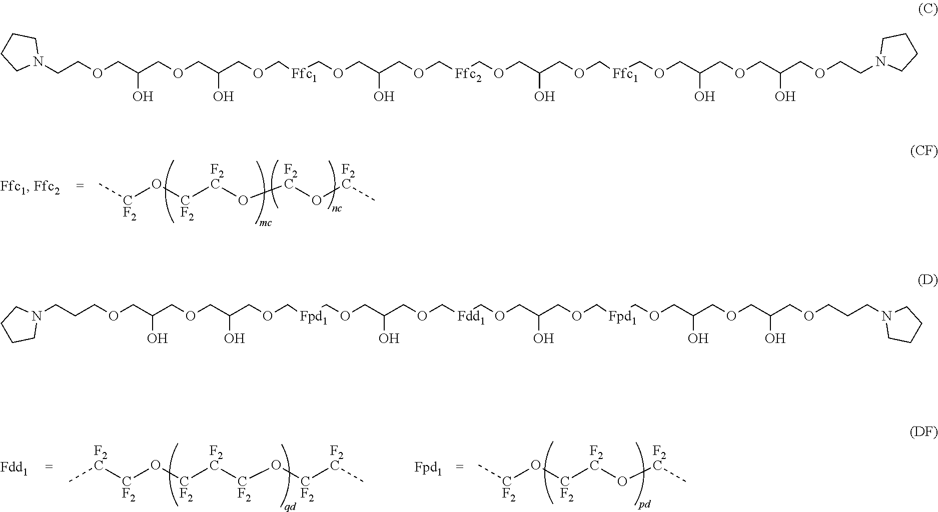

(in Formula (C), Ffc₁ and Ffc₂ are represented by Formula (CF); in Ffc₁ and Ffc₂, me and nc indicate average degrees of polymerization, and are each 0.1 to 20; and me and nc in Ffc₁ and me and nc in Ffc₂ may be the same as or different from each other)
(in Formula (D), Fdd₁ and Fpd₁ are represented by Formula (DF); in Fdd₁, qd indicates an average degree of polymerization, and represents 0.1 to 20; and in Fpd₁, pd indicates an average degree of polymerization, and represents 0.1 to 20).

In the compound represented by the following Formula (E), R¹ and R⁹ are represented by Formula (2), the tertiary amine is a piperidine group, and a in Formula (2-1) is 2. R³ and R⁷ are PFPE chains represented by Formula (8), and R⁵ is a PFPE chain represented by Formula (7).

In the compound represented by the following Formula (F), R¹ and R⁹ are represented by Formula (2), the tertiary amine is a hexamethyleneimine group, and a in Formula (2-1) is 2. R³ and R⁷ are PFPE chains represented by Formula (6), and R⁵ is a PFPE chain represented by Formula (7).

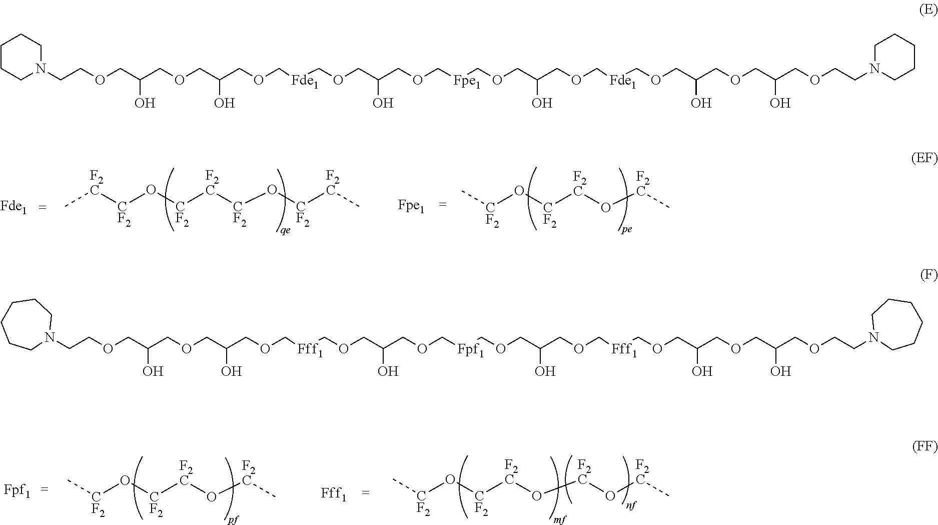

(in Formula (E), Fde₁ and Fpe₁ are represented by Formula (EF); in Fde₁, qe indicates an average degree of polymerization and represents 0.1 to 20; and in Fpe₁, pe indicates an average degree of polymerization and represents 0.1 to 20)
(in Formula (F), Fpf₁ and Fff₁ are represented by Formula (FF); in Fpf₁, pf indicates an average degree of polymerization and represents 0.1 to 20; and in Fff₁, mf and nf indicate average degrees of polymerization, and are each 0.1 to 20).

In the compound represented by the following Formula (G), R¹ and R⁹ are represented by Formula (2), the tertiary amine is a diethylamino group, and a in Formula (2-1) is 2. All of R³, R⁵, and R⁷ are PFPE chains represented by Formula (7).

In the compound represented by the following Formula (H), R¹ and R⁹ are represented by Formula (2). The tertiary amine in R¹ is a dimethylamino group, and a in R¹ in Formula (2-1) is 3. The tertiary amine in R⁹ is a diethylamino group, and a in R⁹ in Formula (2-1) is 2. In R² and RA, f in Formula (5) is 2, in R⁴, b in Formula (3) is 3 and c is 1, and in R⁶, d in Formula (4) is 3 and e is 1. All of R³, R⁵, and R⁷ are PFPE chains represented by Formula (8).

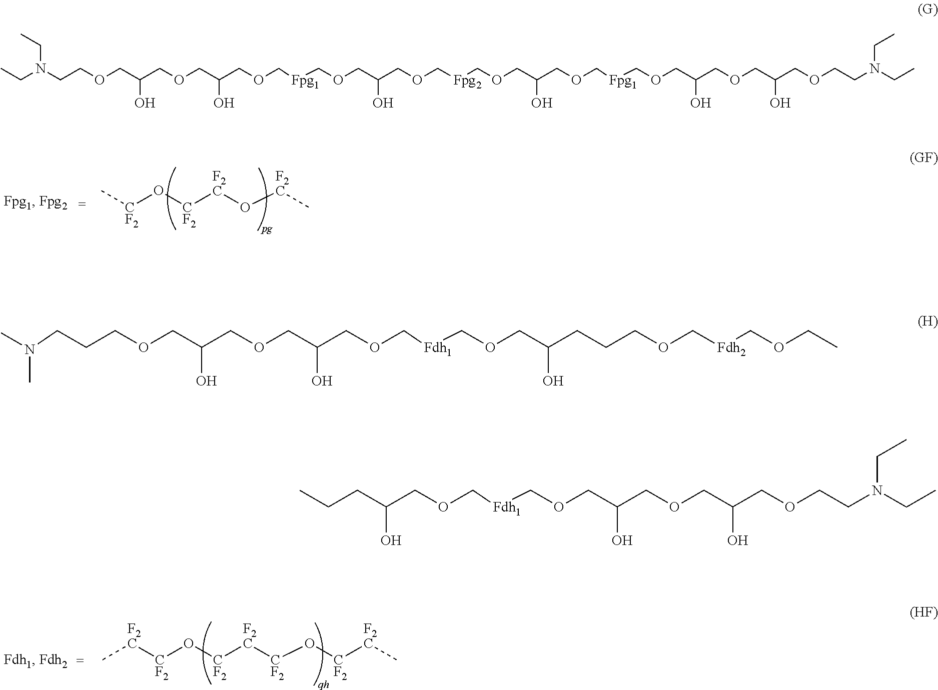

(in Formula (G), Fpg₁ and Fpg₂ are represented by Formula (GF); in Fpg₁ and Fpg₂, pg indicates an average degree of polymerization, and represents 0.1 to 20; and pg in Fpg₁ and pg in Fpg₂ may be the same as or different from each other)
(in Formula (H), Fdh₁ and Fdh₂ are represented by Formula (HF); in Fdh₁ and Fdh₂, qh indicates an average degree of polymerization, and represents 0.1 to 20; and qh in Fdh₁ and qh in Fdh₂ may be the same as or different from each other).

In the compound represented by the following Formula (I), R¹ and R⁹ are represented by Formula (2), the tertiary amine is a morpholine group, and a in Formula (2-1) is 2. In R² and R⁸, f in Formula (5) is 1, in R⁴, b in Formula (3) is 1 and c is 1, and in R⁶, d in Formula (4) is 1 and e is 1. All of R³, R⁵, and R⁷ are PFPE chains represented by Formula (8).

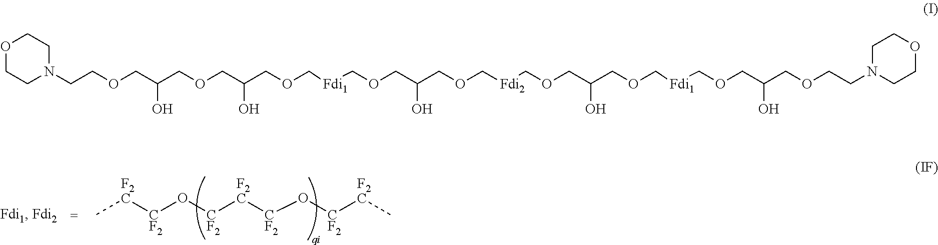

(in Formula (I), Fdi₁ and Fdi₂ are represented by Formula (IF); in Fdi₁ and Fdi₂, qi indicates an average degree of polymerization, and is 0.1 to 20; and qi in Fdi₁ and qi in Fdi₂ may be the same as or different from each other).

When the compound represented by Formula (1) is any of the compounds represented by Formulae (A) to (I), this is preferable because a raw material is easily available, and it is possible to form a lubricating layer having excellent wear resistance and a strong effect of inhibiting corrosion of the magnetic recording medium even if the thickness is thin.

When the compound represented by Formula (1) is any of the compounds represented by Formulae (A) to (E), and (G), this is particularly preferable because a lubricating layer having excellent wear resistance in the magnetic recording medium can be formed.

The number-average molecular weight (Mn) of the fluorine-containing ether compound of the present embodiment is preferably in a range of 400 to 10,000, more preferably in a range of 450 to 7,000, and particularly preferably in a range of 500 to 4,500. As necessary, 800 to 4,000, 1,000 to 3,500, 1,500 to 3,000, 1,800 to 2,800, or 2,000 to 2,500 may be used. When the number-average molecular weight is 400 or more, the lubricant containing the fluorine-containing ether compound of the present embodiment is less likely to evaporate, and it is possible to prevent the lubricant from evaporating and transferring to a magnetic head. In addition, when the number-average molecular weight is 10,000 or less, the viscosity of the fluorine-containing ether compound becomes appropriate, and when a lubricant containing this is applied, a thin lubricating layer can be easily formed. The number-average molecular weight is more preferably 4,500 or less because the viscosity becomes one that makes the lubricant easy to handle.

The number-average molecular weight of the fluorine-containing ether compound (Mn) is a value measured through ¹H-NMR and ¹⁹F-NMR using a AVANCE III 400 (commercially available from Bruker BioSpin). In the measurement of nuclear magnetic resonance (NMR), a sample is diluted with a single solvent such as hexafluorobenzene, d-acetone, and d-tetrahydrofuran or a mixed solvent, and used for measurement. The standard for ¹⁹F-NMR chemical shift is −164.7 ppm for the peak of hexafluorobenzene. The standard for ¹H-NMR chemical shift is 2.2 ppm for the peak of acetone.

### “Production Method”

The method of producing the fluorine-containing ether compound of the present embodiment is not particularly limited, and conventionally known production methods can be used for production. The fluorine-containing ether compound of the present embodiment can be produced by, for example, the following production methods.

### <First Production Method>

In the first production method, a case in which a compound having a symmetrical structure centered on R⁵ is produced as the fluorine-containing ether compound represented by Formula (1) will be exemplified. Specifically, a case in which a compound in which three PFPE chains represented by R³, R⁵, and R⁷ in Formula (1) have the same structure, R¹ and R⁹ are the same, R² and R⁸ are the same, and R⁴ and R⁶ are the same is produced will be exemplified.

### (First Reaction)

First, a fluorine-based compound in which hydroxymethyl groups (—CH₂OH) are disposed at both ends of the PFPE chain corresponding to R⁵ in Formula (1) is prepared. Next, the hydroxyl group of the hydroxymethyl group disposed at both ends of the fluorine-based compound is reacted with a halogen compound having an epoxy group corresponding to R⁴(═R⁶) (first reaction). Therefore, an intermediate compound 1 having an epoxy group corresponding to R⁴(═R⁶) at both ends of the PFPE chain corresponding to R⁵ is obtained.

When the fluorine-containing ether compound of the present embodiment is produced, examples of halogen compounds having an epoxy group used in the first reaction include epichlorohydrin, epibromohydrin, 2-(2-bromoethyl)oxirane, 2-(2-chloroethyl)oxirane, 2-(3-bromopropyl)oxirane, and 2-(3-chloropropyl)oxirane. In Formula (1), when b in Formula (3) representing R⁴ and/or d in Formula (4) representing R⁶ is 2, as a halogen compound having an epoxy group, for example, 2-(2-bromoethyl)oxirane, 2-(2-chloroethyl)oxirane or the like can be used. In Formula (1), when b in Formula (3) representing R⁴ and/or d in Formula (4) representing R⁶ is 3, as a halogen compound having an epoxy group, for example, 2-(3-bromopropyl)oxirane, 2-(3-chloropropyl)oxirane or the like can be used.

### (Second Reaction)

Next, a fluorine-based compound in which hydroxymethyl groups (—CH₂OH) are disposed at both ends of the PFPE chain corresponding to R³(═R⁵═R⁷) in Formula (1) is prepared. Then, the hydroxyl group of the hydroxymethyl group disposed at one end of the fluorine-based compound and an epoxy compound having a structure corresponding to R¹—O—R²—(═—R⁸—O—R⁹) in Formula (1) are reacted (second reaction). Therefore, an intermediate compound 2 having a structure corresponding to R¹—O—R²—(═—R⁸—O—R⁹) at one end of the PFPE chain corresponding to R³(═R⁷) is obtained.

The epoxy compound having a structure corresponding to R¹—O—R²—(═—R⁸—O—R⁹) may protect the hydroxyl group of a structure corresponding to R¹—O—R²—(═—R⁸—O—R⁹) using an appropriate protecting group and may then be reacted with the fluorine-based compound.

When the fluorine-containing ether compound of the present embodiment is produced, the epoxy compound having a structure corresponding to R¹—O—R²—(═—R⁸—O—R⁹) which is used in the second reaction can be synthesized, for example, by reacting an alcohol having a structure corresponding to R¹(═R⁹) of the fluorine-containing ether compound to be produced with a compound having an epoxy group. Examples of compounds having an epoxy group include epichlorohydrin, epibromohydrin, 2-bromoethyloxirane, and allyl glycidyl ether. When the epoxy compound having a structure corresponding to R¹—O—R²—(═—R⁸—O—R⁹) is synthesized, a method of oxidizing unsaturated bonds may be used. In addition, for the epoxy compound having a structure corresponding to R¹—O—R²—(═—R⁸—O—R⁹), a commercial product may be purchased and used.

### (Third Reaction)

Then, the hydroxyl group of the hydroxymethyl group disposed at one end of the intermediate compound 2 is reacted with the epoxy group disposed at both ends of the intermediate compound 1 (third reaction).

When the above processes are performed, it is possible to produce a compound in which three PFPE chains represented by R³, R⁵, and R⁷ in Formula (1) have the same structure, R¹ and R⁹ are the same, R² and R⁸ are the same, and R⁴ and R⁶ are the same. Here, the order of the first reaction and the second reaction may be reversed.

### <Second Production Method>

In the second production method, a case in which a compound in which R³, R⁵, and R⁷ are the same, R⁴ and R⁶ are the same, and any one or both of R² and R⁸, and R¹ and R⁹ are different from each other is produced as the fluorine-containing ether compound represented by Formula (1) are exemplary examples.

In the second production method, in the same manner as in the first production method, a first reaction is performed.

Next, in the second production method, in the second reaction, the hydroxyl group of the hydroxymethyl group disposed at one end of the fluorine-based compound having a PFPE chain corresponding to R³(═R⁵═R⁷) is reacted with an epoxy compound having a structure corresponding to R¹—O—R²— in Formula (1) to synthesize an intermediate compound 2a. In addition, in the second production method, in the second reaction, the hydroxyl group of the hydroxymethyl group disposed at one end of the fluorine-based compound having a PFPE chain corresponding to R⁷ (═R³═R⁵) is reacted with an epoxy compound having a structure corresponding to —R⁸—O—R⁹ in Formula (1) to synthesize an intermediate compound 2b.

Then, in the third reaction, a method of sequentially reacting the hydroxymethyl group of the intermediate compound 2a and the hydroxymethyl group of the intermediate compound 2b with the epoxy group corresponding to R⁴(═R⁶) which is disposed at each end of the intermediate compound 1 can be used for production.

### <Third Production Method>

In the third production method, a case in which a compound in which any one or both of R² and R⁸ and R¹ and R⁹ are different from each other, R⁴ and R⁶ are the same, R³ and R⁷ are the same, and the PFPE chain represented by R⁵ is different from the PFPE chains represented by R³ and R⁷ is produced as the fluorine-containing ether compound represented by Formula (1) will be exemplified.

In the third production method, in the same manner as in the first production method and the second production method, a first reaction is performed.

Next, in the third production method, a fluorine-based compound having a PFPE chain corresponding to R³(═R⁷) in the second reaction having a different PFPE chain type from the fluorine-based compound having a PFPE chain corresponding to R⁵ used in the first reaction is used. Except for this, in the same manner as in the second production method, in the second reaction, an fluorine-based compound having a PFPE chain corresponding to R³(═R⁷) is reacted with an epoxy compound having a structure corresponding to R¹—O—R²— to synthesize an intermediate compound 2c. Similarly, a fluorine-based compound having a PFPE chain corresponding to R⁷ (═R³) is reacted with an epoxy compound having a structure corresponding to —R⁸—O—R⁹ to synthesize an intermediate compound 2d.

Then, in the third reaction, a method of sequentially reacting the hydroxymethyl group of the intermediate compound 2c and the hydroxymethyl group of the intermediate compound 2d with the epoxy group corresponding to R⁴(═R⁶) disposed at each end of the intermediate compound 1 can be used for production.

In the third production method, a compound in which the PFPE chain represented by R³ and the PFPE chain represented by R⁷ are different from each other may be produced. In this case, in the second reaction, a compound is used which is a fluorine-based compound to be reacted with an epoxy compound having a structure corresponding to R¹—O—R²— and has a PFPE chain type which is different from that of a fluorine-based compound to be reacted with an epoxy compound having a structure corresponding to —R⁸—O—R⁹.

### <Fourth Production Method>

In the fourth production method, a case in which a compound in which R³, R⁵, and R⁷ are the same, R² and R⁸ are the same, R¹ and R⁹ are the same, and R⁴ and R⁶ are different from each other is produced as the fluorine-containing ether compound represented by Formula (1) will be exemplified.

In the fourth production method, in the first reaction, a fluorine-based compound in which a hydroxymethyl group (—CH₂OH) is disposed at both ends of the PFPE chain corresponding to R⁵ in Formula (1) is prepared. Next, the hydroxyl group of the hydroxymethyl group disposed at one end of the fluorine-based compound is reacted with a halogen compound having an epoxy group corresponding to R⁴. Then, the hydroxyl group of the hydroxymethyl group disposed at the other end of the fluorine-based compound is reacted with a halogen compound having an epoxy group corresponding to R⁶. Therefore, an intermediate compound 1′ having an epoxy group corresponding to R⁴ at one end of the PFPE chain corresponding to R⁵ and an epoxy group corresponding to R⁶ at the other end is obtained.

Next, in the fourth production method, in the same manner as in the first production method, a second reaction is performed to synthesize an intermediate compound 2.

Then, in the third reaction, it can be produced by a method in which the hydroxyl group of the hydroxymethyl group disposed at one end of the intermediate compound 2 is reacted with the epoxy group corresponding to R⁴ and R⁶ disposed at respective ends of the intermediate compound 1′.

Here, the function of the lubricating layer formed on the protective layer using the lubricant containing the fluorine-containing ether compound of the present embodiment will be described.

As a cause of corrosion of the magnetic recording medium, ionic contamination substances present on the surface of the magnetic recording medium may be exemplified. Many ionic contamination substances adhere from the outside during the process of producing magnetic recording media. Ionic contamination substances can also be produced when environmental substances that have entered the hard disk drive (magnetic recording and reproducing device) adhere to the magnetic recording medium. Specifically, for example, when a magnetic recording medium and/or a hard disk drive is left under high temperature and high humidity conditions, water containing environmental substances such as ions may adhere to the surface of the magnetic recording medium. When water containing environmental substances such as ions passes through the lubricating layer formed on the surface of the magnetic recording medium, it condenses minute ionic components present under the lubricating layer to produce ionic contamination substances.

Since the fluorine-containing ether compound of the present embodiment is the compound represented by Formula (1), the lubricating layer containing this has excellent wear resistance and a strong corrosion-inhibiting effect that prevents contamination substances from entering the inside of the magnetic recording medium. This effect is obtained by the synergistic effect of the lubricating layer containing the fluorine-containing ether compound of the present embodiment, having excellent adhesion to the protective layer, having appropriate hydrophobicity, and being easily formed in a uniform coating state on the protective layer.

More specifically, the fluorine-containing ether compound represented by Formula (1) has end groups each independently containing a tertiary amine represented by Formula (2) (R¹ and R⁹) at both ends. This tertiary amine has appropriate fluidity. Therefore, when the fluorine-containing ether compound contained in the lubricant is adsorbed to the protective layer, excessive steric hindrance does not occur. Therefore, in the lubricating layer containing the fluorine-containing ether compound represented by Formula (1), the adsorption force with respect to the protective layer is not reduced by R¹ and R⁹. As a result, the lubricating layer containing the fluorine-containing ether compound represented by Formula (1) is easily formed in a uniform coating state on the protective layer and has a favorable coating rate. In addition, since the tertiary amine contained in R¹ and R⁹ has appropriate fluidity, the lubricating layer containing this can alleviate collision between the magnetic head and the protective layer before the magnetic head that had approached the protective layer collides with the protective layer. Therefore, it is speculated that floating of the magnetic head is less likely to become unstable, collision between the magnetic head and the protective layer is inhibited, and excellent wear resistance is exhibited.

In addition, the lubricating layer containing the fluorine-containing ether compound represented by Formula (1) is brought into close contact with the protective layer by one or more polar groups contained in each of R², R⁴, R⁶ and R⁸, and the nitrogen atom of the tertiary amine contained in each of R¹ and R⁹. As a result, the lubricating layer prevents contamination substances from entering the inside of the magnetic recording medium, and inhibits corrosion of the magnetic recording medium.

In addition, in the fluorine-containing ether compound represented by Formula (1), three perfluoropolyether chains (R³, R⁵, R⁷) are disposed between R² and R⁴, between R⁴ and R⁶, and between R⁶ and R⁸. Therefore, the distance between the polar group in R² and the polar group in R⁴, the distance between the polar group in R⁴ and the polar group in R⁶, and the distance between the polar group in R⁶ and the polar group in R⁸ are all appropriate. Therefore, all polar groups in R², R⁴, R⁶, and R⁸ are unlikely to be inhibited from binding with active sites on the protective layer by adjacent polar groups. Accordingly, all the polar groups in R², R⁴, R⁶, and R⁸ are likely to be involved in binding with the active sites on the protective layer. In other words, all the polar groups of the fluorine-containing ether compound represented by Formula (1) are unlikely to become polar groups that are not involved in binding with the active sites on the protective layer. As a result, in the lubricating layer containing the fluorine-containing ether compound represented by Formula (1), the number of polar groups that are not involved in binding with the active sites on the protective layer is reduced and the adhesion to the protective layer is excellent.

In addition, the fluorine-containing ether compound represented by Formula (1) has three perfluoropolyether chains (R³, R⁵, R⁷). In the lubricating layer containing the fluorine-containing ether compound represented by Formula (1), each perfluoropolyether chain covers the surface of the protective layer, has low surface energy, and imparts appropriate hydrophobicity (water resistance) to the lubricating layer. As a result, the lubricating layer containing the fluorine-containing ether compound represented by Formula (1) is difficult for water to pass through, can prevent water from entering the inside of the magnetic recording medium, and improves corrosion resistance of the magnetic recording medium.

### [Lubricant for Magnetic Recording Medium]

A lubricant for a magnetic recording medium of the present embodiment contains the fluorine-containing ether compound represented by Formula (1).

The lubricant of the present embodiment can be used by being mixed with a known material used as a material for the lubricant as necessary, as long as the characteristics which are obtained due to the inclusion of the fluorine-containing ether compound represented by Formula (1) are not impaired.

Specific examples of known materials include, for example, FOMBLIN (registered trademark) ZDIAC, FOMBLIN ZDEAL, and FOMBLIN AM-2001 (all commercially available from Solvay Solexis), and Moresco A20H (commercially available from Moresco Corporation). A known material used in combination with the lubricant of the present embodiment preferably has a number-average molecular weight of 400 to 10,000.

When the lubricant of the present embodiment contains a material other than the fluorine-containing ether compound represented by Formula (1), the amount of the fluorine-containing ether compound represented by Formula (1) in the lubricant of the present embodiment is preferably 50 mass % or more, and more preferably 70 mass % or more. The amount of the fluorine-containing ether compound represented by Formula (1) may be 80 mass % or more or 90 mass % or more.

Since the lubricant of the present embodiment contains the fluorine-containing ether compound represented by Formula (1), it is possible to form a lubricating layer having excellent wear resistance and a strong effect of inhibiting corrosion of the magnetic recording medium. Since the lubricating layer made of the lubricant of the present embodiment has excellent wear resistance and a strong effect of inhibiting corrosion of the magnetic recording medium, it can be made thinner.

### [Magnetic Recording Medium]

The magnetic recording medium of the present embodiment has at least a magnetic layer, a protective layer and a lubricating layer that are sequentially provided on a substrate.

In the magnetic recording medium of the present embodiment, as necessary, one, two or more underlayers can be provided between the substrate and the magnetic layer. In addition, an adhesive layer and/or a soft magnetic layer can be provided between the underlayer and the substrate.

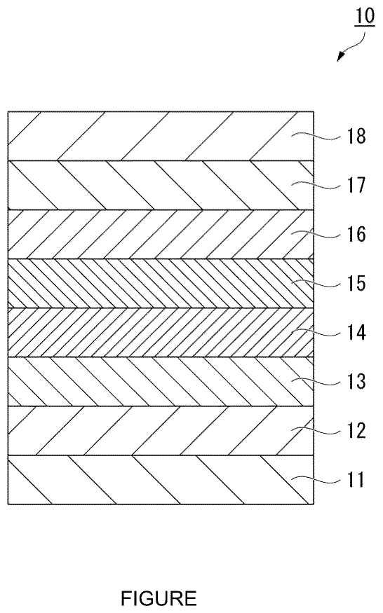

FIG. 1 is a schematic cross-sectional view showing one embodiment of the magnetic recording medium of the present invention.

A magnetic recording medium 10 of the present embodiment has a structure in which an adhesive layer 12, a soft magnetic layer 13, a first underlayer 14, a second underlayer 15, a magnetic layer 16, a protective layer 17, and a lubricating layer 18 are sequentially provided on a substrate 11.

### “Substrate”

As the substrate 11, for example, a non-magnetic substrate in which a film made of NiP or a NiP alloy is formed on a base made of a metal or an alloy material such as Al or an Al alloy can be used.

In addition, as the substrate 11, a non-magnetic substrate made of a non-metal material such as glass, a ceramic, silicon, silicon carbide, carbon, and a resin may be used, or a non-magnetic substrate in which a film made of NiP or a NiP alloy is formed on a base of these non-metal materials may be used.

### “Adhesive Layer”

The adhesive layer 12 prevents the progress of corrosion of the substrate 11 that occurs when the substrate 11 and the soft magnetic layer 13 provided on the adhesive layer 12 are disposed in contact with each other.

The material of the adhesive layer 12 can be appropriately selected from among, for example, Cr, a Cr alloy, Ti, a Ti alloy, CrTi, NiAl, and an AlRu alloy. The adhesive layer 12 can be formed by, for example, a sputtering method.

### “Soft Magnetic Layer”

The soft magnetic layer 13 preferably has a structure in which a first soft magnetic film, an intermediate layer made of a Ru film, and a second soft magnetic film are sequentially laminated. That is, the soft magnetic layer 13 preferably has a structure in which an intermediate layer made of a Ru film is interposed between two soft magnetic film layers, and thus the soft magnetic films above and below the intermediate layer are bonded by anti-ferromagnetic coupling (AFC).

Examples of materials of the first soft magnetic film and the second soft magnetic film include a CoZrTa alloy and a CoFe alloy.

It is preferable to add any of Zr, Ta, and Nb to the CoFe alloy used for the first soft magnetic film and the second soft magnetic film. Thereby, the amorphization of the first soft magnetic film and the second soft magnetic film is promoted, the orientation of the first underlayer (seed layer) can be improved, and the floating height of the magnetic head can be reduced.

The soft magnetic layer 13 can be formed by, for example, a sputtering method.

### “First Underlayer”

The first underlayer 14 is a layer that controls the orientations and the crystal sizes of the second underlayer 15 and the magnetic layer 16 provided thereon.

Examples of the first underlayer 14 include a Cr layer, a Ta layer, a Ru layer, a CrMo alloy layer, a CoW alloy layer, a CrW alloy layer, a CrV alloy layer, and a CrTi alloy layer.

The first underlayer 14 can be formed by, for example, a sputtering method.

### “Second Underlayer”

The second underlayer 15 is a layer that controls the orientation of the magnetic layer 16 such that it becomes favorable. The second underlayer 15 is preferably a layer made of Ru or a Ru alloy.

The second underlayer 15 may be a single layer or may be composed of a plurality of layers. When the second underlayer 15 is composed of a plurality of layers, all of the layers may be composed of the same material, or at least one layer may be composed of a different material.

The second underlayer 15 can be formed by, for example, a sputtering method.

### “Magnetic Layer”

The magnetic layer 16 is made of a magnetic film in which the axis of easy magnetization is in a direction perpendicular to or horizontal to the surface of the substrate. The magnetic layer 16 is a layer containing Co and Pt, and may be a layer containing an oxide, Cr, B, Cu, Ta, Zr or the like in order to further improve SNR characteristics.

Examples of oxides contained in the magnetic layer 16 include SiO₂, SiO, Cr₂O₃, CoO, Ta₂O₃, and TiO₂.

The magnetic layer 16 may be composed of a single layer or may be composed of a plurality of magnetic layers made of materials with different compositions.

For example, when the magnetic layer 16 is composed of three layers including a first magnetic layer, a second magnetic layer and a third magnetic layer sequentially laminated from below, the first magnetic layer preferably has a granular structure made of a material containing Co, Cr, and Pt, and further containing an oxide. As the oxide contained in the first magnetic layer, for example, it is preferable to use an oxide of Cr, Si, Ta, Al, Ti, Mg, Co or the like. Among these, particularly, TiO₂, Cr₂O₃, SiO₂ or the like can be preferably used. In addition, the first magnetic layer is preferably made of a composite oxide in which two or more oxides are added. Among these, particularly, Cr₂O₃—SiO₂, Cr₂O₃—TiO₂, SiO₂—TiO₂ or the like can be preferably used.

The first magnetic layer can contain one or more elements selected from among B, Ta, Mo, Cu, Nd, W, Nb, Sm, Tb, Ru, and Re in addition to Co, Cr, Pt and an oxide.

For the second magnetic layer, the same material as for the first magnetic layer can be used. The second magnetic layer preferably has a granular structure.

The third magnetic layer preferably has a non-granular structure made of a material containing Co, Cr, and Pt and not containing an oxide. The third magnetic layer can contain one or more elements selected from among B, Ta, Mo, Cu, Nd, W, Nb, Sm, Tb, Ru, Re, and Mn in addition to Co, Cr, and Pt.

When the magnetic layer 16 is formed of a plurality of magnetic layers, it is preferable to provide a non-magnetic layer between adjacent magnetic layers. When the magnetic layer 16 is composed of three layers including a first magnetic layer, a second magnetic layer and a third magnetic layer, it is preferable to provide a non-magnetic layer between the first magnetic layer and the second magnetic layer and between the second magnetic layer and the third magnetic layer.

For the non-magnetic layer provided between adjacent magnetic layers of the magnetic layer 16, for example, Ru, a Ru alloy, a CoCr alloy, a CoCrX1 alloy (X1 represents one, two or more elements selected from among Pt, Ta, Zr, Re, Ru, Cu, Nb, Ni, Mn, Ge, Si, O, N, W, Mo, Ti, V, and B) or the like can be preferably used.

For the non-magnetic layer provided between adjacent magnetic layers of the magnetic layer 16, it is preferable to use an alloy material containing an oxide, a metal nitride, or a metal carbide. Specifically, as the oxide, for example, SiO₂, Al₂O₃, Ta₂O₅, Cr₂O₃, MgO, Y₂O₃, TiO₂ or the like can be used. As the metal nitride, for example, AlN, Si₃N₄, TaN, CrN or the like can be used. As the metal carbide, for example, TaC, BC, SiC or the like can be used.

The non-magnetic layer can be formed by, for example, a sputtering method.

The magnetic layer 16 is preferably a magnetic layer for perpendicular magnetic recording in which the axis of easy magnetization is in a direction perpendicular to the surface of the substrate in order to realize a higher recording density. The magnetic layer 16 may be a magnetic layer for in-plane magnetic recording.

The magnetic layer 16 may be formed by any conventionally known method such as a vapor deposition method, an ion beam sputtering method, and a magnetron sputtering method. The magnetic layer 16 is generally formed by a sputtering method.

### “Protective Layer”

The protective layer 17 protects the magnetic layer 16. The protective layer 17 may be composed of one layer or may be composed of a plurality of layers. Examples of materials of the protective layer 17 include carbon, nitrogen-containing carbon, and silicon carbide.

As the protective layer 17, a carbon-based protective layer can be preferably used, and an amorphous carbon protective layer is particularly preferable. When the protective layer 17 is a carbon-based protective layer, this is preferable because the interaction with the hydroxyl group contained in the fluorine-containing ether compound of the lubricating layer 18 is further improved.

The adhesive force between the carbon-based protective layer and the lubricating layer 18 can be controlled by forming a carbon-based protective layer with hydrogenated carbon and/or nitrogenated carbon and adjusting the hydrogen content and/or nitrogen content in the carbon-based protective layer. The hydrogen content in the carbon-based protective layer measured by a hydrogen forward scattering (HFS) method is preferably 3 to 20 atom %. In addition, the nitrogen content in the carbon-based protective layer measured through X-ray photoelectron spectroscopy (XPS) is preferably 4 to 15 atom %.

Hydrogen and/or nitrogen contained in the carbon-based protective layer need not be uniformly contained through the entire carbon-based protective layer. For example, the carbon-based protective layer is preferably formed as a composition gradient layer in which nitrogen is contained in the protective layer 17 on the side of the lubricating layer 18 and hydrogen is contained in the protective layer 17 on the side of the magnetic layer 16. In this case, the adhesive force between the magnetic layer 16 and the lubricating layer 18, and the carbon-based protective layer is further improved.

The film thickness of the protective layer 17 may be 1 nm to 7 nm. When the film thickness of the protective layer 17 is 1 nm or more, the performance of the protective layer 17 can be sufficiently obtained. The film thickness of the protective layer 17 is preferably 7 nm or less in order to reduce the thickness of the protective layer 17.

As a film formation method for the protective layer 17, a sputtering method using a target material containing carbon, a chemical vapor deposition (CVD) method using a hydrocarbon raw material such as ethylene or toluene, an ion beam deposition (IBD) method or the like can be used.

When a carbon-based protective layer is formed as the protective layer 17, for example, a film can be formed by a DC magnetron sputtering method. Particularly, when a carbon-based protective layer is formed as the protective layer 17, it is preferable to form an amorphous carbon protective layer by a plasma CVD method. The amorphous carbon protective layer formed by the plasma CVD method has uniform surfaces and low roughness.

### “Lubricating Layer”

The lubricating layer 18 prevents contamination of the magnetic recording medium 10. In addition, the lubricating layer 18 reduces a frictional force of a magnetic head of a magnetic recording and reproducing device, which slides on the magnetic recording medium 10, and improves the durability of the magnetic recording medium 10.

As shown in FIG. 1, the lubricating layer 18 is formed on and in contact with the protective layer 17. The lubricating layer 18 contains the above fluorine-containing ether compound.

When the protective layer 17 arranged below the lubricating layer 18 is a carbon-based protective layer, particularly, the lubricating layer 18 is bonded to the protective layer 17 with a high bonding force. As a result, even if the thickness of the lubricating layer 18 is thin, it is easy to obtain the magnetic recording medium 10 in which the surface of the protective layer 17 is covered at a high coating rate, and it is possible to effectively prevent contamination of the surface of the magnetic recording medium 10.

The average film thickness of the lubricating layer 18 is preferably 0.5 nm (5 Å) to 2.0 nm (20 Å) and more preferably 0.5 nm (5 Å) to 1.0 nm (10 Å). When the average film thickness of the lubricating layer 18 is 0.5 nm or more, the lubricating layer 18 is formed with a uniform film thickness without forming an island shape or a mesh shape. Therefore, the surface of the protective layer 17 can be coated with the lubricating layer 18 at a high coating rate. In addition, when the average film thickness of the lubricating layer 18 is 2.0 nm or less, the lubricating layer 18 can be made sufficiently thin, and the floating height of the magnetic head can be sufficiently reduced.

When the surface of the protective layer 17 is not sufficiently covered with the lubricating layer 18 at a high coating rate, an environmental substance adsorbed to the surface of the magnetic recording medium 10 passes through voids in the lubricating layer 18 and intrudes under the lubricating layer 18. The environmental substance that has intruded under the lubricating layer 18 is adsorbed and bonded to the protective layer 17, and produces a contamination substance. During magnetic recording and reproducing, the produced contamination substance (aggregated component) adheres (transfers) to a magnetic head as a smear to break the magnetic head or degrade the magnetic recording and reproducing characteristics of magnetic recording and reproducing devices.

Examples of environmental substances that produce contamination substances include siloxane compounds (cyclic siloxane and linear siloxane), ionic impurities, hydrocarbons having a relatively high molecular weight such as octacosane, and plasticizers such as dioctyl phthalate. Examples of metal ions that are contained in ionic impurities include sodium ions and potassium ions. Examples of inorganic ions contained in ionic impurities include chloride ions, bromide ions, nitrate ions, sulfate ions, and ammonium ions. Examples of organic ions contained in ionic impurities include oxalate ions and formate ions.

### “Method of Forming Lubricating Layer”

Examples of methods of forming the lubricating layer 18 include a method in which a magnetic recording medium during production in which respective layers up to the protective layer 17 are formed on the substrate 11 is prepared, and a solution for forming a lubricating layer is applied onto the protective layer 17 and dried.

The lubricating layer forming solution can be obtained by dispersing and dissolving the lubricant for a magnetic recording medium of the embodiment described above in a solvent as necessary, and adjusting the viscosity and concentration to be suitable for application methods.

Examples of solvents used for the lubricating layer forming solution include fluorine-based solvents such as Vertrel (registered trademark) XF (product name, commercially available from Du Pont-Mitsui Fluorochemicals Co., Ltd.).

The method of applying the lubricating layer forming solution is not particularly limited, and examples thereof include a spin coating method, a spraying method, a paper coating method, and a dipping method.

When the dipping method is used, for example, the following method can be used. First, the substrate 11 in which respective layers up to the protective layer 17 are formed is immersed in the lubricating layer forming solution contained in an immersion tank of a dip coating device. Next, the substrate 11 is lifted from the immersion tank at a predetermined speed. Accordingly, the lubricating layer forming solution is applied to the surface of the protective layer 17 of the substrate 11.

When the dipping method is used, the lubricating layer forming solution can be uniformly applied to the surface of the protective layer 17, and the lubricating layer 18 with a uniform film thickness can be formed on the protective layer 17.

In the present embodiment, after the lubricating layer 18 is formed on the surface of the substrate 11, it is preferable to perform a burnishing (precision polishing) process. When the burnishing process is performed, it is possible to remove projection defects and particles present on the surface of the substrate 11 on which the lubricating layer 18 is formed, and the magnetic recording medium 10 with a smooth surface is obtained. When the surface of the magnetic recording medium 10 is smooth, it is possible to reduce the spacing loss between the magnetic recording medium 10 and magnetic head and to improve signal characteristics.

The burnishing process can be, for example, a process of scanning the surface of the substrate 11 on which the lubricating layer 18 is formed with a burnishing tape. As the burnishing tape, for example, one made of a resin film retaining abrasive grains can be used. The grain size of the abrasive grains can be, for example, #6,000 to #20,000.

In the present embodiment, the substrate 11 in which the lubricating layer 18 is formed is preferably subjected to a heat treatment. When the heat treatment is performed, the adhesion between the lubricating layer 18 and the protective layer 17 is improved, and the adhesive force between the lubricating layer 18 and the protective layer 17 is improved.

The heat treatment temperature is preferably 100 to 180° C. When the heat treatment temperature is 100° C. or higher, an effect of improving the adhesion between the lubricating layer 18 and the protective layer 17 is sufficiently obtained. In addition, when the heat treatment temperature is 180° C. or lower, it is possible to prevent the thermal decomposition of the lubricating layer 18. The heat treatment time is preferably 10 to 120 minutes.

In the magnetic recording medium 10 of the present embodiment, at least the magnetic layer 16, the protective layer 17, and the lubricating layer 18 are sequentially provided on the substrate 11. In the magnetic recording medium 10 of the present embodiment, the lubricating layer 18 containing the above fluorine-containing ether compound is formed on and in contact with the protective layer 17. The lubricating layer 18 has excellent wear resistance and a strong effect of inhibiting corrosion of the magnetic recording medium 10. Therefore, the magnetic recording medium 10 of the present embodiment has a small amount of contamination substances present on the surface, excellent wear resistance and corrosion resistance, and favorable reliability and durability. In addition, since the magnetic recording medium 10 of the present embodiment has lubricating layer 18 having excellent wear resistance and a strong effect of inhibiting corrosion, it is possible to reduce the thickness of the protective layer 17 and/or the lubricating layer 18. In addition, the lubricating layer 18 in the magnetic recording medium 10 of the present embodiment is less likely to generate foreign matter (smear) and can reduce the occurrence of pickup.

### EXAMPLES

Hereinafter, the present invention will be described in more detail with reference to examples and comparative examples. Here, the present invention is not limited to the following examples.

### Example 1

The compound represented by Formula (A) was produced by the following method.

### (First Reaction)

13.9 g (20 mmol) of a compound (a number-average molecular weight of 693, a molecular weight distribution of 1.1) represented by HOCH₂CF₂CF₂O(CF₂CF₂CF₂O)_{q}CF₂CF₂CH₂OH (in the formula, q indicating an average degree of polymerization is 2.5), 1.76 g of 60% sodium hydride (44 mmol), and 15.6 mL of N,N-dimethylformamide were put into a 200 mL eggplant flask under a nitrogen gas atmosphere, and the mixture was stirred at room temperature until it became uniform. 3.45 mL of epibromohydrin (42 mmol) was additionally added to this uniform solution, and the mixture was stirred and reacted at 40° C. for 2 hours.

The reaction product obtained after the reaction was cooled to 25° C., 80 mL of water was added and mixed, and the reaction was suspended. The obtained mixed solution was transferred into a separatory funnel and extracted twice with 150 mL of ethyl acetate. The extracted organic layer was washed with a saturated saline solution and dehydrated with anhydrous sodium sulfate. After the drying agent was filtered, the filtrate was concentrated, and the residue was purified through silica gel column chromatography to obtain 4.8 g of a compound (a molecular weight of 805, 6.0 mmol) represented by the following Formula (11) as an intermediate compound 1.

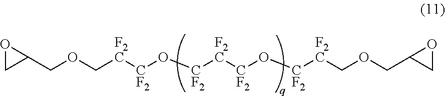

(in Formula (11), q indicating an average degree of polymerization is 2.5).

### (Second Reaction)

20.8 g of a compound (a number-average molecular weight of 693, a molecular weight distribution of 1.1) represented by HOCH₂CF₂CF₂O(CF₂CF₂CF₂O)_{q}CF₂CF₂CH₂OH (in the formula, q indicating an average degree of polymerization is 2.5), 6.4 g of an epoxy compound (a molecular weight of 354.4, 18 mmol) represented by the following Formula (12), and 28 mL of t-butanol were put into 200 mL eggplant flask under a nitrogen gas atmosphere, and the mixture was stirred at room temperature until it became uniform. 1.0 g of potassium tert-butoxide (a molecular weight of 112.2, 9 mmol) was additionally added to this uniform solution, and the mixture was stirred and reacted at 70° C. for 16 hours.

The epoxy compound represented by Formula (12) was synthesized by the following method. Allyl glycidyl ether was reacted with the primary hydroxyl group of 4-(2-hydroxyethyl)morpholine. The secondary hydroxyl group of the obtained compound was protected with a tetrahydropyranyl (THP) group, and the terminal double bond was oxidized. Through the above process, the epoxy compound represented by Formula (12) was obtained.

The reaction product obtained after the reaction was cooled to 25° C., transferred into a separatory funnel containing 100 mL of water, and extracted three times with 100 mL of ethyl acetate. The extracted organic layer was washed with water and dehydrated with anhydrous sodium sulfate. After the drying agent was filtered, the filtrate was concentrated, and the residue was purified through silica gel column chromatography to obtain 14.3 g (a molecular weight of 1,187.9, 12.0 mmol) of a compound represented by the following Formula (13) as an intermediate compound 2.

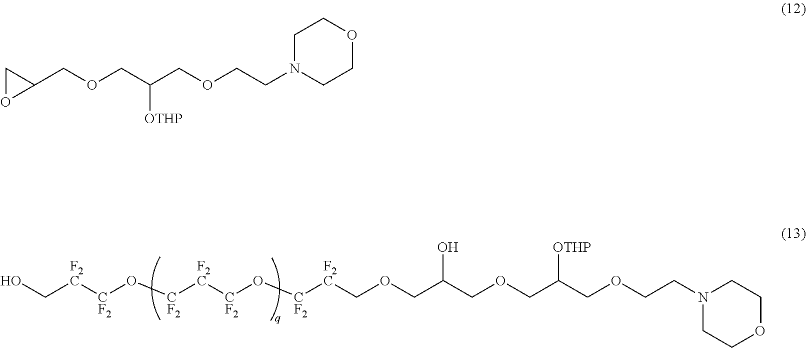

(in Formula (12), THP represents a tetrahydropyranyl group)
(in Formula (13), q indicating an average degree of polymerization is 2.5; and THP represents a tetrahydropyranyl group).

### (Third Reaction)

10.5 g of an intermediate compound 2 (in the formula, q indicating an average degree of polymerization is 2.5) represented by Formula (13), 0.34 g of potassium tert-butoxide, and 9.4 mL of t-butanol were put into a 200 mL eggplant flask under a nitrogen gas atmosphere, and the mixture was stirred at room temperature until it became uniform. 2.4 g of an intermediate compound 1 (in the formula, q indicating an average degree of polymerization is 2.5) represented by Formula (11) was additionally added to this uniform solution, and the mixture was stirred and reacted at 70° C. for 16 hours.

The reaction product obtained after the reaction was cooled to 25° C., transferred into a separatory funnel containing 100 mL of water, and extracted three times with 100 mL of ethyl acetate. The extracted organic layer was washed with water and dehydrated with anhydrous sodium sulfate. After the drying agent was filtered, the filtrate was concentrated, and the residue was purified through silica gel column chromatography to obtain 4.89 g of the compound (a molecular weight of 2,714, 1.8 mmol) represented by Formula (A) (in Formula (A), Fda₁ and Fda₂ are represented by Formula (AF), and qa in Fda₁ and Fda₂ indicating average degrees of polymerization is 2.5).

The obtained compound (A) was subjected to ¹H-NMR and ¹⁹F-NMR measure, and the structure was identified based on the following results.

¹H-NMR (CD₃COCD₃): δ [ppm]=2.51 to 2.66 (12H), 3.44 to 4.51 (60H)

¹⁹F-NMR (CD₃COCD₃): δ [ppm]=−84.0 to −83.0 (30F), −86.4 (12F), −124.3 (12F), −130.0 to −129.0 (15F)

### Example 2

The same operation as in Example 1 was performed except that, in place of the compound represented by HOCH₂CF₂CF₂O(CF₂CF₂CF₂O)_{q}CF₂CF₂CH₂OH (in the formula, q indicating an average degree of polymerization is 2.5) in the first reaction, 9.4 g of a compound (a number-average molecular weight of 468, a molecular weight distribution of 1.1) represented by HOCH₂CF₂O(CF₂CF₂O)ₚCF₂CH₂OH (in the formula, p indicating an average degree of polymerization is 2.5) was used, in the second reaction, in place of the compound represented by HOCH₂CF₂CF₂O(CF₂CF₂CF₂O)_{q}CF₂CF₂CH₂OH (in the formula, q indicating an average degree of polymerization is 2.5), 14.0 g of a compound (a number-average molecular weight of 468, a molecular weight distribution of 1.1) represented by HOCH₂CF₂O(CF₂CF₂O)ₚCF₂CH₂OH (in the formula, p indicating an average degree of polymerization is 2.5) was used, and in place of the epoxy compound represented by Formula (12), 6.47 g of an epoxy compound represented by the following Formula (14) was used, and thereby 3.72 g of the compound (a molecular weight of 2,067, 1.8 mmol) represented by Formula (B) (in Formula (B), Fpb₁ and Fpb₂ are represented by Formula (BF), and pb in Fpb₁ and Fpb₂ indicating average degrees of polymerization is 2.5) was obtained.

The epoxy compound represented by Formula (14) was synthesized by the following method. Allyl glycidyl ether was reacted with the primary hydroxyl group of 4-(3-hydroxypropyl)morpholine. The secondary hydroxyl group of the obtained compound was protected with a tetrahydropyranyl (THP) group, and the terminal double bond was oxidized. Through the above process, the epoxy compound represented by Formula (14) was obtained.

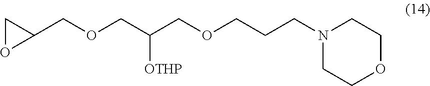

(in Formula (14), THP represents a tetrahydropyranyl group).

The obtained compound (B) was subjected to ¹H-NMR and ¹⁹F-NMR measure, and the structure was identified based on the following results.

¹H-NMR (CD₃COCD₃): δ [ppm]=1.77 to 1.81 (4H), 2.51 to 2.66 (12H), 3.44 to 4.51 (60H)

¹⁹F-NMR (acetone-D₆): δ [ppm]=−78.6 (6F), −81.3 (6F), −90.0 to −88.5 (30F)

### Example 3

The same operation as in Example 1 was performed except that, in place of the compound represented by HOCH₂CF₂CF₂O(CF₂CF₂CF₂O)_{q}CF₂CF₂CH₂OH (in the formula, q indicating an average degree of polymerization is 2.5) in the first reaction, 12.7 g of a compound (a number-average molecular weight of 633, a molecular weight distribution of 1.1) represented by HOCH₂CF₂O(CF₂CF₂O)ₘ(CF₂O)ₙCF₂CH₂OH (in the formula, m indicating an average degree of polymerization is 2.5, and n indicating an average degree of polymerization is 2.5) was used, in the second reaction, in place of the compound represented by HOCH₂CF₂CF₂O(CF₂CF₂CF₂O)_{q}CF₂CF₂CH₂OH (in the formula, q indicating an average degree of polymerization is 2.5), 19.0 g of a compound (a number-average molecular weight of 633, a molecular weight distribution of 1.1) represented by HOCH₂CF₂O(CF₂CF₂O)ₘ(CF₂O)ₙCF₂CH₂OH (in the formula, m indicating an average degree of polymerization is 2.5, and n indicating an average degree of polymerization is 2.5) was used, and in place of the epoxy compound represented by Formula (12), 5.94 g of an epoxy compound represented by the following Formula (15) was used, and thereby 4.50 g of the compound (a molecular weight of 2,502, 1.8 mmol) represented by Formula (C) (in Formula (C), Ffc₁ and Ffc₂ are represented by Formula (CF), me and nc in Ffc₁ and Ffc₂ indicating average degrees of polymerization are each 2.5) was obtained.

The epoxy compound represented by Formula (15) was synthesized by the following method. Allyl glycidyl ether was reacted with the primary hydroxyl group of 1-(2-hydroxyethyl)pyrrolidine. The secondary hydroxyl group of the obtained compound was protected with a tetrahydropyranyl (THP) group, and the terminal double bond was oxidized. Through the above process, the epoxy compound represented by Formula (15) was obtained.

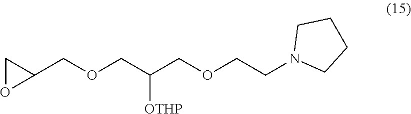

(in Formula (15), THP represents a tetrahydropyranyl group).

The obtained compound (C) was subjected to ¹H-NMR and ¹⁹F-NMR measure, and the structure was identified based on the following results.

¹H-NMR (CD₃COCD₃): δ [ppm]=1.76 to 1.82 (8H), 2.51 to 2.66 (12H), 3.44 to 4.51 (52H)

¹⁹F-NMR (CD₃COCD₃): δ [ppm]=−55.6 to −50.6 (15F), −77.7 (6F), −80.3 (6F), −91.0 to −88.5 (30F)

### Example 4

The same operation as in Example 1 was performed except that, in place of the compound represented by HOCH₂CF₂CF₂O(CF₂CF₂CF₂O)_{q}CF₂CF₂CH₂OH (in the formula, q indicating an average degree of polymerization is 2.5) in the second reaction, 14.0 g of a compound represented by HOCH₂CF₂O(CF₂CF₂O)ₚCF₂CH₂OH (in the formula, p indicating an average degree of polymerization is 2.5) was used, and in place of the epoxy compound represented by Formula (12), 6.18 g of an epoxy compound represented by the following Formula (16) was used, and thereby 4.07 g of the compound (a molecular weight of 2,260, 1.8 mmol) represented by Formula (D) (in Formula (D), Fdd₁ and Fpd₁ are represented by Formula (DF), qd in Fdd₁ indicating an average degree of polymerization is 2.5, and pd in Fpd₁ indicating an average degree of polymerization is 2.5) was obtained.

The epoxy compound represented by Formula (16) was synthesized by the following method. Allyl glycidyl ether was reacted with the primary hydroxyl group of 1-(3-hydroxypropyl)pyrrolidine. The secondary hydroxyl group of the obtained compound was protected with a tetrahydropyranyl (THP) group, and the terminal double bond was oxidized. Through the above process, the epoxy compound represented by Formula (16) was obtained.

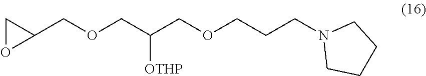

(in Formula (16), THP represents a tetrahydropyranyl group).

The obtained compound (D) was subjected to ¹H-NMR and ¹⁹F-NMR measure, and the structure was identified based on the following results.

¹H-NMR (CD₃COCD₃): δ [ppm]=1.76 to 1.81 (12H), 2.51 to 2.66 (12H), 3.44 to 4.51 (52H)

¹⁹F-NMR (acetone-D₆): δ [ppm]=−78.6 (4F), −81.3 (4F), −84.0 to −83.0 (10F), −86.4 (4F), −90.0 to −88.5 (20F), −124.3 (4F), −130.0 to −129.0 (5F)

### Example 5

The same operation as in Example 2 was performed except that, in place of a compound represented by HOCH₂CF₂O(CF₂CF₂O)ₚCF₂CH₂OH (in the formula, p indicating an average degree of polymerization is 2.5) in the second reaction, 20.8 g of a compound represented by HOCH₂CF₂CF₂O(CF₂CF₂CF₂O)_{q}CF₂CF₂CH₂OH (in the formula, q indicating an average degree of polymerization is 2.5) was used, and in place of the epoxy compound represented by Formula (14), 6.18 g of an epoxy compound represented by the following Formula (17) was used, and thereby 4.47 g of the compound (a molecular weight of 2,485, 1.8 mmol) represented by Formula (E) (in Formula (E), Fde₁ and Fpe₁ are represented by Formula (EF), qe in Fde₁ indicating an average degree of polymerization is 2.5, and pe in Fpe₁ indicating an average degree of polymerization is 2.5) was obtained.

The epoxy compound represented by Formula (17) was synthesized by the following method. Allyl glycidyl ether was reacted with the primary hydroxyl group of 1-(2-hydroxyethyl)piperidine. The secondary hydroxyl group of the obtained compound was protected with a tetrahydropyranyl (THP) group, and the terminal double bond was oxidized. Through the above process, the epoxy compound represented by Formula (17) was obtained.

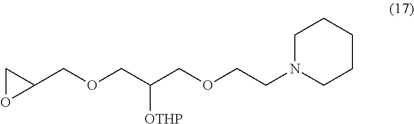

(in Formula (17), THP represents a tetrahydropyranyl group).

The obtained compound (E) was subjected to ¹H-NMR and ¹⁹F-NMR measure, and the structure was identified based on the following results.

¹H-NMR (CD₃COCD₃); δ [ppm]=1.76 to 1.81 (12H), 2.51 to 2.66 (12H), 3.45 to 4.54 (52H)

¹⁹F-NMR (acetone-D₆): δ [ppm]=−78.6 (2F), −81.3 (2F), −84.0 to −83.0 (20F), −86.4 (8F), −90.0 to −88.5 (10F), −124.3 (8F), −130.0 to −129.0 (10F)

### Example 6

The same operation as in Example 2 was performed except that, in place of a compound represented by HOCH₂CF₂O(CF₂CF₂O)ₚCF₂CH₂OH (in the formula, p indicating an average degree of polymerization is 2.5) in the second reaction, 19.0 g of a compound represented by HOCH₂CF₂O(CF₂CF₂O)ₘ(CF₂O)ₙCF₂CH₂OH (in the formula, m indicating an average degree of polymerization is 2.5, and n indicating an average degree of polymerization is 2.5) was used, and in place of the epoxy compound represented by Formula (14), 6.43 g of an epoxy compound represented by the following Formula (18) was used, and thereby 4.31 g of the compound (a molecular weight of 2,393, 1.8 mmol) represented by Formula (F) (in Formula (F), Fpf₁ and Fff₁ are represented by Formula (FF), pf in Fpf₁ indicating an average degree of polymerization is 2.5, and mf and nf in Fff₁ indicating an average degree of polymerization are each 2.5) was obtained

The epoxy compound represented by Formula (18) was synthesized by the following method. Allyl glycidyl ether was reacted with the primary hydroxyl group of hexahydro-TH-azepine-1-ethanol. The secondary hydroxyl group of the obtained compound was protected with a tetrahydropyranyl (THP) group, and the terminal double bond was oxidized. Through the above process, the epoxy compound represented by Formula (18) was obtained.

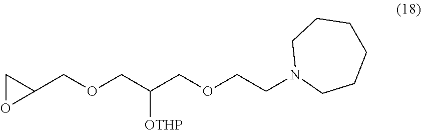

(in Formula (18), THP represents a tetrahydropyranyl group).

The obtained compound (F) was subjected to ¹H-NMR and ¹⁹F-NMR measure, and the structure was identified based on the following results.

¹H-NMR (CD₃COCD₃): δ [ppm]=1.76 to 1.88 (16H), 2.51 to 2.67 (12H), 3.44 to 4.51 (52H)

¹⁹F-NMR (CD₃COCD₃): δ [ppm]=−55.6 to −50.6 (10F), −77.7 (4F), −78.6 (2F), −80.3 (4F), −81.3 (2F), −90.0 to −88.5 (30F)

### Example 7

The same operation as in Example 2 was performed except that, in place of the epoxy compound represented by Formula (14) in the second reaction, 5.61 g of an epoxy compound represented by the following Formula (19) was used, and thereby 3.62 g of the compound (a molecular weight of 2,011, 1.8 mmol) represented by Formula (G) (in Formula (G), Fpg₁ and Fpg₂ are represented by Formula (GF), and pg in Fpg₁ and Fpg₂ indicating an average degree of polymerization is 2.5) was obtained.

The epoxy compound represented by Formula (19) was synthesized by the following method. Allyl glycidyl ether was reacted with the primary hydroxyl group of 2-diethylaminoethanol. The secondary hydroxyl group of the obtained compound was protected with a tetrahydropyranyl (THP) group, and the terminal double bond was oxidized. Through the above process, the epoxy compound represented by Formula (19) was obtained.

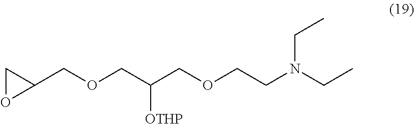

(in Formula (19), THP represents a tetrahydropyranyl group).

The obtained compound (G) was subjected to ¹H-NMR and ¹⁹F-NMR measure, and the structure was identified based on the following results.

¹H-NMR (CD₃COCD₃): δ [ppm]=1.03 (12H), 2.50 to 2.58 (12H), 3.44 to 4.51 (52H)

¹⁹F-NMR (CD₃COCD₃): δ [ppm]=−78.6 (6F), −81.3 (6F), −90.0 to −88.5 (30F)

### Example 8

An intermediate compound 1 (a molecular weight of 861.4, 4.0 mmol) of Example 8 was obtained in the same manner as in the compound represented by Formula (11) synthesized in Example 1 except that, in place of epibromohydrin in the first reaction, 2-(3-bromopropyl)oxirane was used.

An intermediate compound 2a (a molecular weight 779.45, 4.0 mmol) of Example 8 was obtained in the same manner as in the compound represented by Formula (13) synthesized in Example 1 except that, in place of the epoxy compound represented by Formula (12) in the second reaction, the epoxy compound represented by Formula (19) was used.

In addition, an intermediate compound 2b (a molecular weight of 1,004.6, 4.0 mmol) of Example 8 was obtained in the same manner as in the compound represented by Formula (13) synthesized in Example 1 except that, in place of the epoxy compound represented by Formula (12) in the second reaction, the epoxy compound represented by the following Formula (20) was used.

The epoxy compound represented by Formula (20) was synthesized by the following method. Allyl glycidyl ether was reacted with the primary hydroxyl group of 3-(dimethylamino)-1-propanol. The secondary hydroxyl group of the obtained compound was protected with a tetrahydropyranyl (THP) group, and the terminal double bond was oxidized. Through the above process, the epoxy compound represented by Formula (20) was obtained.

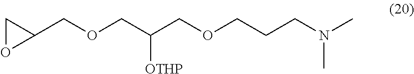

(in Formula (20), THP represents a tetrahydropyranyl group).

3.9 g of the intermediate compound 2a of Example 8, 0.17 g of potassium tert-butoxide, and 9.4 mL of t-butanol were put into a 200 mL eggplant flask under a nitrogen gas atmosphere, and the mixture was stirred at room temperature until it became uniform. 2.6 g of the intermediate compound 1 of Example 8 was additionally added to this uniform solution, and the mixture was stirred and reacted at 70° C. for 16 hours. 5.02 g of the intermediate compound 2b of Example 8, and 0.17 g of potassium tert-butoxide were added to the reaction solution after the reaction, and the mixture was stirred and reacted at 70° C. for 16 hours.

The reaction product obtained after the reaction was cooled to 25° C., transferred into a separatory funnel containing 100 mL of water, and extracted three times with 100 mL of ethyl acetate. The extracted organic layer was washed with water and dehydrated with anhydrous sodium sulfate. After the drying agent was filtered, the filtrate was concentrated, and the residue was purified through silica gel column chromatography to obtain 4.91 g of the compound (a molecular weight of 2,728, 1.8 mmol) represented by Formula (H) (in Formula (H), Fdh₁ and Fdh₂ are represented by Formula (HF), and qh in Fdh₁ and Fdh₂ indicating an average degree of polymerization is 2.5).

The obtained compound (H) was subjected to ¹H-NMR and ¹⁹F-NMR measure, and the structure was identified based on the following results.

¹H-NMR (CD₃COCD₃): δ [ppm]=1.03 (6H), NEt21.36 to 1.57 (8H), 1.66 to 1.70 (2H), 2.27 (6H), 2.50 to 2.60 (8H), 3.37 to 4.31 (52H)

¹⁹F-NMR (CD₃COCD₃): δ [ppm]=−84.0 to −83.0 (30F), −86.4 (12F), −124.3 (12F), −130.0 to −129.0 (15F)

### Example 9

The same operation as in Example 1 was performed except that, in place of the epoxy compound represented by Formula (12) in the second reaction, 3.62 g of an epoxy compound represented by the following Formula (21) was used, and thereby 4.67 g of the compound (a molecular weight of 2,594, 1.8 mmol) represented by Formula (I) (in Formula (I), Fdi₁ and Fdi₂ are represented by Formula (IF), and qi in Fdi₁ and Fdi₂ indicating an average degree of polymerization is 2.5) was obtained.

The epoxy compound represented by Formula (21) was synthesized by reacting the primary hydroxyl group of 4-(2-hydroxyethyl)morpholine with epibromohydrin.

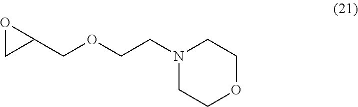 [SMILES: C1CN(CCOCC2CO2)CCO1]

The obtained compound (I) was subjected to ¹H-NMR and ¹⁹F-NMR measure, and the structure was identified based on the following results.

¹H-NMR (CD₃COCD₃): δ [ppm]=2.51 to 2.66 (12H), 3.44 to 4.51 (28H)

¹⁹F-NMR (CD₃COCD₃): δ [ppm]=−84.0 to −83.0 (30F), −86.4 (12F), −124.3 (12F), −130.0 to −129.0 (15F)

### Comparative Example 1

The compound represented by the following Formula (J) was synthesized by the method described in Patent Document 1.

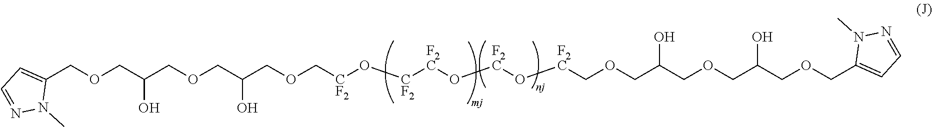

(in Formula (J), mj and nj indicating average degrees of polymerization are each 4.5).

### Comparative Example 2

The compound represented by the following Formula (K) was synthesized by the method described in Patent Document 2.

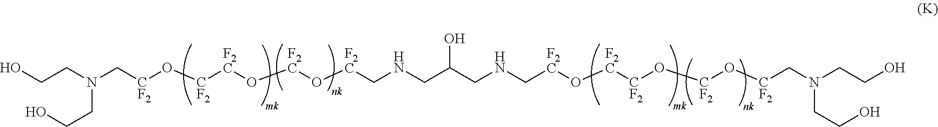

(in Formula (K), mk and nk indicating average degrees of polymerization are each 4.5).

### Comparative Example 3

The compound represented by the following Formula (L) was synthesized by the method described in Patent Document 4.

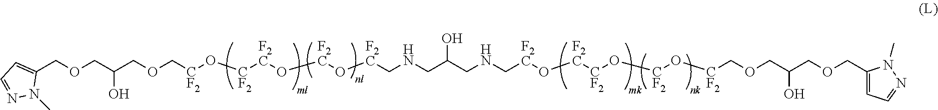

(in Formula (L), ml and nl indicating average degrees of polymerization are each 4.5).

### Comparative Example 4

The compound represented by the following Formula (M) was synthesized by the method described in Patent Document 5.

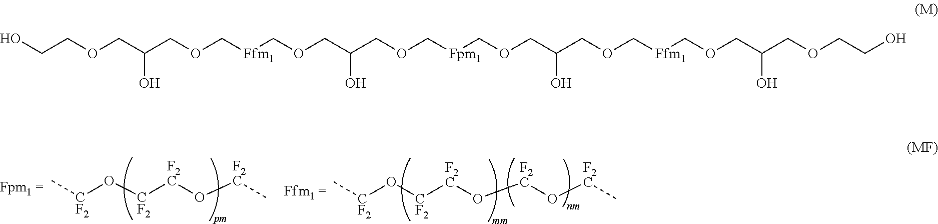

(in Formula (M), Ffm₁ and Fpm₁ are represented by Formula (MF), mm and nm in Ffm₁ indicating average degrees of polymerization are each 2.5, and pm in Fpm₁ indicating an average degree of polymerization is 2.5).

### Comparative Example 5

The compound represented by the following Formula (N) was synthesized by the method described in Patent Document 7.

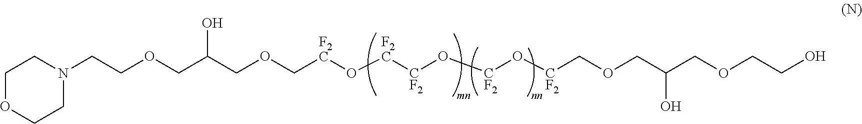

(in Formula (N), mn and nn indicating average degrees of polymerization are each 4.5).

Table 1 shows the structure of R¹, the structure of R² and R⁸ (f in Formula (5)), the structure of R⁴ (b and c in Formula (3)), the structure of R⁶ (d and e in Formula (4)), the structure of R³ and R⁷ (g and h in Formula (6), i in Formula, and j in Formula (8)), the structure of the R⁵ (g and h in Formula (6), i in Formula (7), and j in Formula (8)), and the structure of R⁹ when the compounds of Examples 1 to 9 obtained in this manner are applied to Formula (1).

TABLE 1

| | | R² and | | | R³ and | | | |
|---|---|---|---|---|---|---|---|---|
| | R¹ | R⁸ | R⁴ | R⁶ | R⁷ | R⁵ | R⁹ | Compound |
| Example 1 | 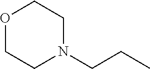 | Formula (5) f = 2 | Formula (3) b = 1 c = 1 | Formula (4) d = 1 e = 1 | Formula (8) j = 2.5 | Formula (8) j = 2.5 | Same as R¹ | (A) |
| Example 2 | 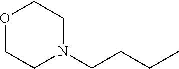 | Formula (5) f = 2 | Formula (3) b = 1 c = 1 | Formula (4) d = 1 e = 1 | Formula (7) i = 2.5 | Formula (7) i = 2.5 | Same as R¹ | (B) |
| Example 3 | 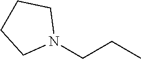 | Formula (5) f = 2 | Formula (3) b = 1 c = 1 | Formula (4) d = 1 e = 1 | Formula (6) g = 2.5 h = 2.5 | Formula (6) g = 2.5 h = 2.5 | Same as R¹ | (C) |
| Example 4 | 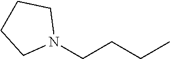 | Formula (5) f = 2 | Formula (3) b = 1 c = 1 | Formula (4) d = 1 e = 1 | Formula (7) i = 2.5 | Formula (8) j = 2.5 | Same as R¹ | (D) |
| Example 5 | 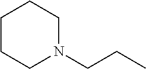 | Formula (5) f = 2 | Formula (3) b = 1 c = 1 | Formula (4) d = 1 e = 1 | Formula (8) j = 2.5 | Formula (7) i = 2.5 | Same as R¹ | (E) |
| Example 6 | 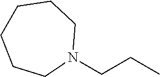 | Formula (5) f = 2 | Formula (3) b = 1 c = 1 | Formula (4) d = 1 e = 1 | Formula (6) g = 2.5 h = 2.5 | Formula (7) i = 2.5 | Same as R¹ | (F) |
| Example 7 | 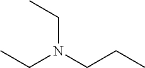 | Formula (5) f = 2 | Formula (3) b = 1 c = 1 | Formula (4) d = 1 e = 1 | Formula (7) i = 2.5 | Formula (7) i = 2.5 | Same as R¹ | (G) |
| Example 8 | 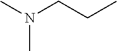 | Formula (5) f = 2 | Formula (3) b = 1 c = 1 | Formula (4) d = 1 e = 1 | Formula (8) j = 2.5 | Formula (8) j = 2.5 | 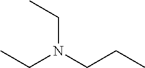 | (H) |
| Example 9 | 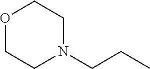 | Formula (5) f = 1 | Formula (3) b = 1 c = 1 | Formula (4) d = 1 e = 1 | Formula (8) j = 2.5 | Formula (8) j = 2.5 | Same as R¹ | (I) |

In addition, the number-average molecular weight (Mn) of the compounds of Examples 1 to 9 and Comparative Examples 1 to 5 was determined by the above ¹H-NMR and ¹⁹F-NMR measurement. The results are shown in Table 2. Here, it is speculated that the value of the average molecular weight of the synthesized compound had a variation of about 1 to 5 due to the molecular weight distribution of the fluoropolyether used as a raw material for the compound, differences in operations when the compound was synthesized, and the like.

TABLE 2

| | | Number- | | | | | |
|---|---|---|---|---|---|---|---|
| | | average | | Corrosion | | | |
| | | molecular | Film | resistance test | | Wear | |
| | | weight | thickness | With | Without | resistance | Overall |
| | Compound | (Mn) | (Å) | burnishing | burnishing | test | evaluation |
| Example 1 | (A) | 2714 | 10 | A | A | A | A |
| Example 2 | (B) | 2067 | 10 | A | A | A | A |
| Example 3 | (C) | 2502 | 10 | A | A | A | A |
| Example 4 | (D) | 2260 | 10 | A | A | A | A |
| Example 5 | (E) | 2485 | 10 | A | A | A | A |
| Example 6 | (F) | 2393 | 10 | A | A | B | A |
| Example 7 | (G) | 2011 | 10 | A | A | A | A |
| Example 8 | (H) | 2728 | 10 | A | A | B | A |
| Example 9 | (I) | 2594 | 10 | A | A | B | A |
| Comparative | (J) | 1485 | 10 | E | E | D | D |
| Example 1 | | | | | | | |
| Comparative | (K) | 2222 | 10 | C | B | D | C |
| Example 2 | | | | | | | |
| Comparative | (L) | 2393 | 10 | B | B | D | C |
| Example 3 | | | | | | | |
| Comparative | (M) | 2083 | 10 | B | A | E | D |
| Example 4 | | | | | | | |
| Comparative | (N) | 1305 | 10 | E | E | A | D |
| Example 5 | | | | | | | |

Next, a solution for forming a lubricating layer was prepared using the compounds obtained in Examples 1 to 9 and Comparative Examples 1 to 5 by the following method. Then, using the obtained solution for forming a lubricating layer, by the following method, a lubricating layer of the magnetic recording medium was formed to obtain magnetic recording media of Examples 1 to 9 and Comparative Examples 1 to 5.

### “Solution for Forming Lubricating Layer”

The compounds obtained in Examples 1 to 9 and Comparative Examples 1 to 5 to 4 were each dissolved in Vertrel (registered trademark) XF (product name, commercially available from Du Pont-Mitsui Fluorochemicals Co., Ltd.) as a fluorine solvent and diluted with Vertrel XF so that the film thickness of the coating film when applied onto the protective layer was 9 Å to 10 Å, and thereby a solution for forming a lubricating layer was obtained.

### “Magnetic Recording Medium”

A magnetic recording medium in which an adhesive layer, a soft magnetic layer, a first underlayer, a second underlayer, a magnetic layer and a protective layer were sequentially provided on a substrate having a diameter of 65 mm was prepared. The protective layer had a thickness of 1 to 5 nm and was made of carbon.

The solution for forming a lubricating layer of Examples 1 to 9 and Comparative Examples 1 to 5 was applied onto the protective layer of the magnetic recording medium in which respective layers up to the protective layer were formed by a dipping method. Here, the dipping method was performed under conditions of an immersion speed of 10 mm/sec, an immersion time of 30 sec, and a lifting speed of 1.2 mm/sec.

Then, a burnishing process of scanning with a burnishing tape retaining abrasive grains with a grain size of #6,000 was performed on the surface of the magnetic recording medium on which the lubricating layer was formed.

The magnetic recording medium after the burnishing process was put into a thermostatic chamber at 120° C. and subjected to a heat treatment of heating for 10 minutes.

Through the above process, magnetic recording media of Examples 1 to 9 and Comparative Examples 1 to 5 (with burnishing) were obtained.

In addition, magnetic recording media of Examples 1 to 9 and Comparative Examples 1 to 5 (without burnishing) were obtained in the same manner as in the magnetic recording media with burnishing except that the burnishing process was not performed.

### (Film Thickness Measurement)

The film thickness of the lubricating layer of the magnetic recording media of Examples 1 to 9 and Comparative Examples 1 to 5 (with or without burnishing) obtained in this manner was measured using a Fourier transform infrared spectrophotometer (FT-IR) (product name: Nicolet iS50, commercially available from Thermo Fisher Scientific). In all of the magnetic recording media of Examples 1 to 9 and Comparative Examples 1 to 5, there was no difference in the film thickness of the lubricating layer between with burnishing and without burnishing. The results are shown in Table 2.

Next, the following corrosion resistance test was performed on the burnished and non-burnished magnetic recording media of Examples 1 to 9 and Comparative Examples 1 to 5.

### (Corrosion Resistance Test)

The magnetic recording medium was exposed under conditions of 85° C. and a relative humidity of 90% for 48 hours. Then, the number of corroded locations on the magnetic recording medium was counted using an optical surface analysis device (Candela7140, commercially available from KLA-Tencor), and evaluated based on the following evaluation criteria. The results are shown in Table 2.

### “Evaluation Criteria”

A: less than 200
B: 200 or more and less than 500
C: 500 or more and less than 800
D: 800 or more and less than 1,000
E: 1,000 or more

Next, the following wear resistance test was performed on the burnished magnetic recording media of Examples 1 to 9 and Comparative Examples 1 to 5.

### (Wear Resistance Test)

Using a pin-on-disc friction and wear tester, an alumina sphere having a diameter of 2 mm as a contact was slid on the lubricating layer of the magnetic recording medium at a load of 40 gf, and a sliding speed of 0.25 m/sec, and the friction coefficient of the surface of the lubricating layer was measured. Then, the sliding time until the friction coefficient of the surface of the lubricating layer sharply increased was measured. The sliding time until the friction coefficient sharply increased was measured four times for the lubricating layer of each magnetic recording medium, and the average value (time) thereof was used as an index of the wear resistance of a lubricant coating film. The friction coefficient increase time was evaluated as follows. Table 2 shows the evaluation results of the magnetic recording media using the compounds of Examples 1 to 9 and Comparative Examples 1 to 5.

### “Evaluation Criteria”

A: 500 sec or longer
B: 400 sec or longer and shorter than 500 sec
C: 300 sec or longer and shorter than 400 sec
D: 200 sec or longer and shorter than 300 sec
E: shorter than 200 sec

Here, the time until the friction coefficient sharply increased could be used as an index of the wear resistance of the lubricating layer for the following reasons. This is because wear of the lubricating layer of the magnetic recording medium proceeded when the magnetic recording medium was used, and when the lubricating layer disappeared due to wear, the contact and the protective layer came into direct contact with each other, and the friction coefficient sharply increased. The time until the friction coefficient sharply increased was thought to be correlated with the friction test.

In addition, the magnetic recording media of Examples 1 to 9 and Comparative Examples 1 to 5 were subjected to overall evaluation based on the following criteria.

The results are shown in Table 2.

### (Overall Evaluation)

A: the results of the corrosion resistance test with and without burnishing were both A, and the result of the wear resistance test was A or B.
B: the results of the corrosion resistance test with and without burnishing were both B, and the result of the wear resistance test was A or B.
C: the results of the corrosion resistance test with and without burnishing were each B or C, and the result of the wear resistance test was C or D
D: at least one of the results of the corrosion resistance test with and without burnishing, and the result of the wear resistance test was E.

As shown in Table 2, in the magnetic recording media of Examples 1 to 9 having a lubricating layer containing the compound represented by Formula (1), both with and without tape burnishing, the results of the corrosion resistance test were all A. In addition, as shown in Table 2, in all of the magnetic recording media of Examples 1 to 9, the sliding time until the friction coefficient sharply increased was long, the result of the wear resistance test was A or B, and the wear resistance was favorable.

As a result, all of the magnetic recording media of Examples 1 to 9 had an overall evaluation of A.

On the other hand, the magnetic recording media of Comparative Example 1, Comparative Example 4 and Comparative Example 5 had an overall evaluation of D, the magnetic recording media of Comparative Example 2 and Comparative Example 3 had an overall evaluation of C, and all of the results were inferior to those of the magnetic recording media of Examples 1 to 9.

More specifically, as shown in Table 2, the magnetic recording medium of Comparative Example 1 had a corrosion resistance test result of E in both cases with and without tape burnishing. In addition, the magnetic recording medium of Comparative Example 2 had a corrosion resistance test result of C with tape burnishing and B without tape burnishing. The magnetic recording medium of Comparative Example 3 had a corrosion resistance test result of B in both cases with and without tape burnishing.

This was speculated to be due to the following reasons. In Examples 1 to 9, the compound contained in the lubricating layer had three PFPE chains in the molecule. On the other hand, in Comparative Examples 1 to 3, the compounds (J), (K), and (L) contained in the lubricating layer had one or two PFPE chains in the molecule. Due to this difference, the water resistance of the lubricating layer in the magnetic recording media of Comparative Examples 1 to 3 was inferior to those of the magnetic recording media of Examples 1 to 9.

In addition, as shown in Table 2, the magnetic recording media of Comparative Examples 1 to 3 had a wear resistance test result of D.

This was speculated to be because, in Comparative Example 1 and Comparative Example 3, the compounds (J) and (L) contained in the lubricating layer had a methylpyrazolylmethyl group at both ends. Although the π bond of the conjugated unsaturated bond contained in the methylpyrazolylmethyl group in the lubricating layer exhibited an interaction with the protective layer, the adhesion to the protective layer was too strong. Therefore, the fluidity of the lubricating layer became insufficient, and the function of alleviating collision between the magnetic head and the protective layer before the magnetic head that had approached the protective layer collided with the protective layer was not sufficiently obtained. As a result, it was speculated that the floating of the magnetic head became unstable, collision between the magnetic head and the protective layer was likely to occur, and the wear resistance result was poor.

In addition, in Comparative Example 2, the compound (K) contained in the lubricating layer had a tertiary amine, in which two hydroxyethyl groups were bonded to a nitrogen atom, at both ends. The hydroxyl group of two hydroxyethyl groups of the tertiary amine had a too strong adsorption force with respect to the protective layer. Moreover, the tertiary amines disposed at both ends of the compound (K) were bonded to the PFPE chain only via a methylene group without an ether bond (—O—). Therefore, due to insufficient flexibility of the molecular structure, it was difficult to form a lubricating layer in a uniform coating state on the protective layer. Accordingly, it was speculated that collision between the magnetic head and the protective layer could not be alleviated, collision between the magnetic head and the protective layer was likely to occur, and the wear resistance result was poor.

In addition, as shown in Table 2, in the magnetic recording medium of Comparative Example 4, the result of the corrosion resistance test without tape burnishing was A, and the result of the corrosion resistance test with tape burnishing was B. However, the magnetic recording medium of Comparative Example 4 had a wear resistance test result of E. This was speculated to be because, in Comparative Example 4, the compound (M) contained in the lubricating layer had no tertiary amine and had hydroxyl groups at both ends. The compound (M) had a too strong adsorption force of the hydroxyl groups disposed at both ends with respect to the protective layer. Therefore, it was speculated that collision between the magnetic head and the protective layer could not be alleviated, collision between the magnetic head and the protective layer tended to occur, and the result of wear resistance was poor.

In addition, as shown in Table 2, the magnetic recording medium of Comparative Example 5 had the wear resistance test result of A. However, the magnetic recording medium of Comparative Example 5 had a corrosion resistance test result of E in both cases with and without tape burnishing.

This is because, in Comparative Example 5, since the compound (N) contained in the lubricating layer had only one PFPE chain in the molecule, the water resistance of the lubricating layer was inferior to those of Examples 1 to 9.

### INDUSTRIAL APPLICABILITY

There is provided a fluorine-containing ether compound that can be preferably used as a material for the lubricant for a magnetic recording medium. When a lubricant for a magnetic recording medium containing the fluorine-containing ether compound of the present invention is used, it is possible to form a lubricating layer having excellent wear resistance and a strong effect of inhibiting corrosion of the magnetic recording medium.

### REFERENCE SIGNS LIST

10 Magnetic recording medium
11 Substrate
12 Adhesive layer
13 Soft magnetic layer
14 First underlayer
15 Second underlayer
16 Magnetic layer
17 Protective layer
18 Lubricating layer

1. A fluorine-containing ether compound represented by Formula (1) shown below: 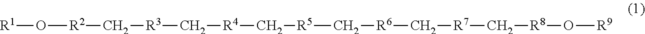
(in Formula (1), R³, R⁵ and R⁷ are the same perfluoropolyether chains or at least one thereof is different; R², R⁴, R⁶ and R⁸ are each independently a divalent linking group having one or more polar groups; and R¹ and R⁹ are each independently an end group containing a tertiary amine, and are represented by Formula (2) shown below) 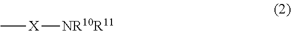
(in Formula (2), X is a divalent hydrocarbon group having 1 to 5 carbon atoms; R¹⁰ and R¹¹ are the same or different aliphatic groups; and R¹⁰ and R¹¹ may form a ring structure together with a nitrogen atom).

2. The fluorine-containing ether compound according to claim 1,
wherein, in Formula (2), —X— is represented by Formula (2-1) shown below: 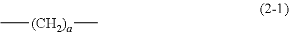
(in Formula (2-1), a is an integer of 2 or 3).

3. The fluorine-containing ether compound according to claim 1,
wherein, in Formula (2), R¹⁰ and R¹¹ are each independently a saturated aliphatic group having 1 to 4 carbon atoms, or R¹⁰ and R¹¹ form a 5- to 7-membered ring together with a nitrogen atom.

4. The fluorine-containing ether compound according to claim 1,
wherein, in Formula (2), —NR¹⁰R¹¹ is a dimethylamino group or a diethylamino group.

5. The fluorine-containing ether compound according to claim 1,
wherein, in Formula (2), —NR¹⁰R¹¹ is any one group selected from a pyrrolidine group, piperidine group, a morpholine group, and a hexamethyleneimine group.

6. The fluorine-containing ether compound according to claim 1,
wherein, in Formula (1), all polar groups in R⁴ and R⁶ are hydroxyl groups.

7. The fluorine-containing ether compound according to claim 1,
wherein, in Formula (1), R⁴ is represented by Formula (3) shown below, and R⁶ is represented by Formula (4) shown below: 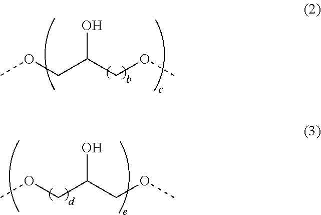
(in Formula (3), b is an integer of 1 to 3, c is an integer of 1 to 2; and an etheric oxygen atom on the left side in Formula (3) is bonded to R³—CH₂— in Formula (1))
(in Formula (4), d is an integer of 1 to 3, e is an integer of 1 to 2; and an etheric oxygen atom on the right side in Formula (4) is bonded to —CH₂—R⁷ in Formula (1)).

8. The fluorine-containing ether compound according to claim 1,
wherein, in Formula (1), all polar groups in R² and R⁸ are hydroxyl groups.

9. The fluorine-containing ether compound according to claim 1,
wherein, in Formula (1), R² and R⁸ are each independently represented by Formula (5) shown below: 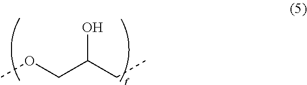
(in Formula (5), f is an integer of 1 to 2; and an etheric oxygen atom in Formula (5) is bonded to CH₂ adjacent to R², or CH₂ adjacent to R⁸ in Formula (1)).

10. The fluorine-containing ether compound according to claim 1,
wherein, in Formula (1), R² and R⁸ each contain two polar groups.

11. The fluorine-containing ether compound according to claim 1,
wherein, in Formula (1), R³, R⁵ and R⁷ are each independently represented by Formula (Rf) shown below: 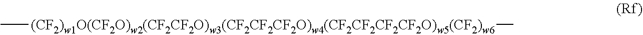
(in Formula (Rf), w2, w3, w4, and w5 indicate average degrees of polymerization, and are each independently 0 to 20; provided that all of w2, w3, w4, and w5 are not 0 at the same time; w1 and w6 are average values indicating the number of —CF₂-'s and are each independently 1 to 3; and the arrangement sequence of repeating units in Formula (Rf) is not particularly limited).

12. The fluorine-containing ether compound according to claim 1,
wherein, in Formula (1), R³, R⁵ and R⁷ are each independently any of Formulae (6) to (10) shown below: 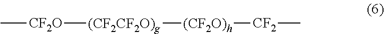
(in Formula (6), g and h indicate average degrees of polymerization, and are each 0.1 to 20) 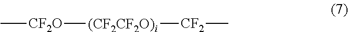
(in Formula (7), i indicates an average degree of polymerization, and is 0.1 to 20) 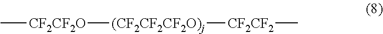
(in Formula (8), j indicates an average degree of polymerization, and is 0.1 to 20) 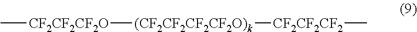
(in Formula (9), k indicates an average degree of polymerization, and is 0.1 to 10) 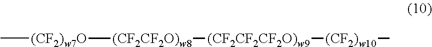
(in Formula (10), w8 and w9 indicate average degrees of polymerization, and are each independently 0.1 to 20; w7 and w10 are average values indicating the number of —CF₂-'s and are each independently 1 to 2).

13. The fluorine-containing ether compound according to claim 1,
wherein, in Formula (1), R¹ and R⁹ are the same.

14. The fluorine-containing ether compound according to claim 1,
wherein, in Formula (1), R² and R⁸ are the same.

15. The fluorine-containing ether compound according to claim 1,
wherein, in Formula (1), R⁴ and R⁶ are the same.

16. The fluorine-containing ether compound according to claim 1, wherein the fluorine-containing ether compound has a number-average molecular weight in a range of 400 to 10,000.

17. A lubricant for a magnetic recording medium comprising the fluorine-containing ether compound according to claim 1.

18. A magnetic recording medium in which at least a magnetic layer, a protective layer, and a lubricating layer are sequentially provided on a substrate,
wherein the lubricating layer contains the fluorine-containing ether compound according to.

19. The magnetic recording medium according to claim 18,
wherein the lubricating layer has an average film thickness of 0.5 nm to 2.0 nm.
